(19) United States
(12) Patent Application Publication
(10) Pub. No.: US 2013/0007848 A1
(43) Pub. Date: Jan. 3, 2013

(54) MONITORING OF SMART MOBILE DEVICES IN THE WIRELESS ACCESS NETWORKS

(75) Inventors: Hemant Chaskar, Los Altos, CA (US); Krishnamurthy Gopinath, Bangalore (IN); Pushkar Prasad, Pune (IN); Prabhash Dhyani, Dehradun (IN)

(73) Assignee: AirTight Networks, Inc., Mountain View, CA (US)

(21) Appl. No.: 13/448,073

(22) Filed: Apr. 16, 2012

Related U.S. Application Data
(60) Provisional application No. 61/521,769, filed on Aug. 10, 2011.
(60) Provisional application No. 61/503,620, filed on Jul. 1, 2011.

(51) Int. Cl. H04W 12/08; G06F 21/00

(52) U.S. Cl. 726/4

(57) ABSTRACT

A method for smart mobile devices monitoring in wireless local area networks. The method includes installing a wireless security monitoring system or a wireless access system in a local area network. The method includes configuring the wireless security monitoring system or the wireless access system to communicate with a mobile device management (MDM) system. The method includes detecting a wireless client connecting to the wireless local area network and identifying the wireless client to be a smart mobile device. Moreover, the method includes receiving an indication at the wireless security monitoring system or the wireless access system from the MDM system regarding whether the wireless client is a managed device or not. The method also includes classifying the wireless client as approved or unapproved smart mobile device based at least upon the indication received from the MDM system.

### CROSS-REFERENCES TO RELATED APPLICATIONS

The present invention claims priority to the U.S. Provisional Application No. 61/521,769, entitled “Monitoring of Smart Mobile Devices in Wireless Access Networks”, filed Aug. 10, 2011, and the U.S. Provisional Application No. 61/503,620, entitled “Policy Driven Monitoring of Smart Phone Devices in Wireless Access Networks”, filed Jul. 1, 2011, each of which is commonly assigned and incorporated by reference herein.

### BACKGROUND OF THE INVENTION

The present invention relates generally to the wireless computer networking techniques. More particularly, the present invention facilitates monitoring and policy enforcement for the smart mobile devices, such as smartphones, tablets, e-readers, etc., when they attempt connection to the wireless networks, such as Wi-Fi networks in the enterprises. Increasing popularity of the smart mobile devices and the associated BYOD (Bring Your Own Device (to work)) concept have resulted into a situation where people carry various types of smart mobile devices having facility to connect to the wireless networks, such as the Wi-Fi networks. These connections can create certain information security risks. The present invention provides techniques for mitigating certain security risks from the use of smart mobile devices in the wireless networks.

### BRIEF SUMMARY OF THE INVENTION

An object of the present invention is to enhance security of the wireless local area computer networks, such as the enterprise Wi-Fi networks, against backdrop of the consumerization of the smart mobile devices. More particularly, the present invention provides method and system to monitor wireless network activity to detect and contain personal smart mobile devices attempting connections into the enterprise wireless networks against the policy.

Smart mobile devices such as iPhones, iPads, Androids, Kindles, and other smartphones, tablets and e-readers have been proliferating. Many of these include wireless communication facility, more particularly Wi-Fi. This current trend creates the possibility of the authorized users of the network connecting to the wireless local area networks, such as office networks, using their personal mobile devices. In particular, the current state-of-the-art in the Wi-Fi access security in the enterprise networks (WPA2 PEAP method), lends itself to authorized users sharing their network access credentials between the authorized devices and the unauthorized personal mobile devices, without the knowledge of the network administrator. Another current state-of-the-art in managing the smart mobile devices (Mobile Device Management (MDM) systems) lacks visibility into the activity of the devices which they don't manage (e.g., personal mobile devices are not controlled by the enterprise MDM systems). The techniques of the present invention facilitate overcoming such limitations of the state-of-the-art approaches.

In a specific embodiment, a method for smart mobile devices monitoring in a computer local area network with wireless extension (wireless local area network) is provided. The method includes installing a wireless security monitoring system comprising one or more sniffers positioned within a selected geographic region for monitoring of wireless communications within the selected geographic region. The one or more sniffers being in communication with a security monitoring server over a computer network. The method includes configuring the security monitoring system to communicate with a mobile device management (MDM) system. The MDM system comprises an MDM server in communication with a plurality of MDM agents on a plurality of managed smart mobile devices. Moreover, the method includes detecting a wireless client operating within the selected geographic region using at least one of the one or more sniffers, and identifying the wireless client to be a smart mobile device. The method includes receiving an indication at the security monitoring system from the MDM system regarding whether the wireless client is a managed device or not. The method also includes classifying the wireless client as approved or unapproved smart mobile device based at least upon the indication received from the MDM system.

In an alternative specific embodiment, a method for smart mobile devices monitoring in a computer local area network with wireless extension (wireless local area network) is provided. The method includes installing a wireless access system comprising one or more wireless access points positioned within a selected geographic region to provide wireless access in a local area network. The one or more wireless access points being in communication with a wireless access management server over a computer network. The method includes configuring the wireless access management server to communicate with a mobile device management (MDM) system. The MDM system comprises an MDM server in communication with a plurality of MDM agents on a plurality of managed smart mobile devices. Moreover, the method includes detecting a wireless client connecting to at least one of the one more wireless access points and identifying the wireless client to be a smart mobile device. The method includes receiving an indication at the wireless access management system from the MDM system regarding whether the wireless client is a managed device or not. The method includes classifying the wireless client as approved or unapproved smart mobile device based at least upon the indication received from the MDM system.

In yet alternative specific embodiment, a method for monitoring personal smart mobile devices in local area computer networks with wireless extensions (wireless local area networks) is provided. The method includes configuring a wireless network access policy for one or more types of smart mobile devices, wherein a type of a smart mobile device being characterized by at least a device hardware type or at least a device operating system type. The method includes ascertaining a connection of a first wireless device to the wireless local area network. Moreover, the method includes determining type of the first wireless device based at least upon one or more fields in one or more packets transmitted by the first wireless device, wherein the one or more fields contain information which is characteristic of the type of the first wireless device. The method also includes ascertaining violation of the wireless network access policy based at least upon the determined type of the first wireless device, and responding to the violation of the wireless network access policy. Associated system is also provided.

These and various other objects, features and advantages of the present invention can be more fully appreciated with reference to the detailed description and accompanying drawings that follow.

### BRIEF DESCRIPTION OF THE DRAWINGS

FIG. 1 illustrates a simplified local area network (LAN) with wireless extensions that can facilitate the smart mobile devices monitoring according to a specific embodiment of the present invention.

FIG. 2 illustrates an exemplary hardware diagram of a sniffer and/or access point device according to a specific embodiment of the present invention.

FIGS. 3, 4, 5A, 5B, 5C, and 5D illustrate certain exemplary packet structures that can be utilized in identifying smart mobile devices/types of smart mobile devices according to certain specific embodiments of the present invention.

FIG. 6 illustrates certain exemplary signatures which can be utilized in identifying smart mobile devices/types of smart mobile devices according to a specific embodiment of the present invention.

FIG. 7 illustrates an exemplary logical flow of steps in identifying smart mobile devices according to a specific embodiment of the present invention.

FIG. 8 illustrates an exemplary logical flow of steps in identifying smart mobile devices according to an alternative specific embodiment of the present invention.

FIG. 9 illustrates an exemplary logical flow of steps in identifying smart mobile devices according to yet alternative specific embodiment of the present invention.

FIG. 10 illustrates an exemplary computer screenshot for configuring certain wireless network access policy for the smart mobile devices according to an embodiment of the present invention.

FIG. 11 illustrates an exemplary flow of steps in a method for smart mobile devices monitoring according to an embodiment of the present invention.

FIG. 12 illustrates an exemplary computer screenshot for configuring certain wireless network access policy for the smart mobile devices according to an alternative embodiment of the present invention.

FIG. 13A illustrates an exemplary network schematic including certain interface between the security monitoring system and the MDM system according to a specific embodiment of the present invention.

FIG. 13B illustrates an exemplary network schematic including certain interface between the wireless access point management system and the MDM system according to an alternative specific embodiment of the present invention.

FIG. 14 illustrates an exemplary flow of steps in a method for smart mobile devices monitoring using information from the MDM system according to a specific embodiment of the present invention.

FIG. 15 illustrates an exemplary computer screenshot for configuring certain wireless network access policy for the smart mobile devices according to a specific embodiment of the present invention.

FIG. 15A illustrates an exemplary computer screenshot for displaying certain smart mobile devices monitoring information according to a specific embodiment of the present invention.

### DETAILED DESCRIPTION OF THE INVENTION

The present invention relates generally to the wireless computer networking techniques. More particularly, the invention provides methods and systems for detecting unauthorized wireless devices, including smart phones and tablets, in the local area networks with wireless extensions. An exemplary wireless computer networking environment consistent with the embodiments of the present invention is the IEEE 802.11 wireless network (commonly referred as Wi-Fi). However, the invention can also be applied in other wireless networking environments as appropriate.

Computer systems have proliferated from academic and specialized science applications to day-to-day business, commerce, information distribution, social media and home applications. Such systems can include personal computing devices (PCs, notebook computers, smart phones, tablets) to large mainframe and server class computers. Powerful mainframe and server class computers run specialized applications for banks, small and large companies, e-commerce vendors, and governments. Personal computing devices are commonly used by people in offices, homes, and even local coffee shops.

The computer systems located within a specific local geographic area (e.g., an office, building floor, building, home, or any other defined geographic region (indoor and/or outdoor)) are typically interconnected using a Local Area Network (LAN)(e.g., the Ethernet). The LANs, in turn, can be interconnected with each other using a Wide Area Network (WAN)(e.g., the Internet). A conventional LAN can be deployed using an Ethernet-based infrastructure comprising cables, hubs switches, and other elements.

Connection ports (e.g., Ethernet ports) can be used to couple multiple computer systems to the LAN. For example, a user can connect to the LAN by physically attaching a computing device (e.g., a laptop, desktop) to one of the connection ports using physical wires or cables. Other types of computer systems, such as database computers, server computers, routers, and Internet gateways, can be connected to the LAN in a similar manner. Once physically connected to the LAN, a variety of network services can be accessed (e.g., file transfer, remote login, email, WWW, database access, and voice over IP).

Using recent (and increasingly popular) wireless technologies, users can now be wirelessly connected to the computer network. Thus, wireless communication can provide wireless access to a LAN in the office, home, public hot-spot, and other geographical locations. The IEEE 802.11 family of wireless protocols (Wi-Fi) is a common standard for such wireless communication. In Wi-Fi, the 802.11b standard provides for wireless connectivity at speeds up to 11 Mbps in the 2.4 GHz radio frequency spectrum; the 802.11g standard provides for even faster connectivity at about 54 Mbps in the 2.4 GHz radio frequency spectrum; and the 802.11a standard provides for wireless connectivity at speeds up to 54 Mbps in the 5 GHz radio frequency spectrum. Moreover, the 802.11n standard provides connectivity at speeds up to 600 Mbps. Even higher speeds can be expected in the future with the upcoming standards such as the 802.11ac.

Advantageously, Wi-Fi can facilitate a quick and effective way of providing a wireless extension to an existing wired LAN. To provide this wireless extension, one or more Wi-Fi access points (APs) can connect to the connection ports either directly or through intermediate equipment, such as Wi-Fi switch. After an AP is connected to a connection port, a user can access the LAN using a device (called a station) equipped with Wi-Fi radio. The station can wirelessly communicate with the AP.

While Wi-Fi has become popular, more recently, people have been increasingly using devices such as smartphones (e.g., iPhone, Android phone, etc.), tablets (e.g., iPad, Android tablet, BlackBerry PlayBook, etc.), e-readers (e.g., Amazon Kindle) and like. These devices have built in Wi-Fi radios in them. People are increasingly sharing such devices between business and personal use. For example, an employee may connect a personal iPhone or iPad to the Wi-Fi network at work without the knowledge of the enterprise security administrator. This creates the possibility of sensitive enterprise data to be stored on the personal smart devices. Storage of enterprise data on the personal smart devices may be undesirable because these smart devices are portable and hence are at a risk of loss or theft.

Moreover, the connection of personal smart devices also creates the possibility of malware and viruses in the personal smart devices sneaking into the enterprise network. For example, “jailbreaking” of iPhone, “rooting” of Android phone are some examples of techniques which allow intrinsic security controls in these devices to be overridden and then allow uncontrolled applications to be installed on them. As merely an example, PC Magazine reported on Mar. 16, 2011 that the Android malware quadrupled in six months (see http://www.pcmag.com/article2/0,2817,2385461,00.asp).

The connection of unauthorized (e.g., personal) smart devices to the corporate network may also violate the network access policy on the enterprise premises. For example, the organization may have officially handed out BlackBerry devices to employees, but may not want Android or other devices to be used to access the corporate LAN over Wi-Fi.

The proliferation of smart mobile devices, such as iPhones, iPads, Androids, e-readers, etc., thus creates additional challenges in managing security risks for the Wi-Fi enabled enterprise networks. Moreover, Wi-Fi authentication and encryption techniques such as WPA2 PEAP, that are currently state-of-the-art in the enterprise Wi-Fi networks, are inadequate to block unauthorized or personal smart mobile devices. In particular, employees can share their WPA2 PEAP usernames and passwords between the authorized (IT assigned) devices and the personal smart mobile devices, and thus connect personal smart mobile devices to the enterprise Wi-Fi networks without the administrator knowledge or permission. Therefore, a need arises for techniques that improve the security for the Wi-Fi environments in light of the proliferation of the smart mobile devices. The present invention provides such techniques.

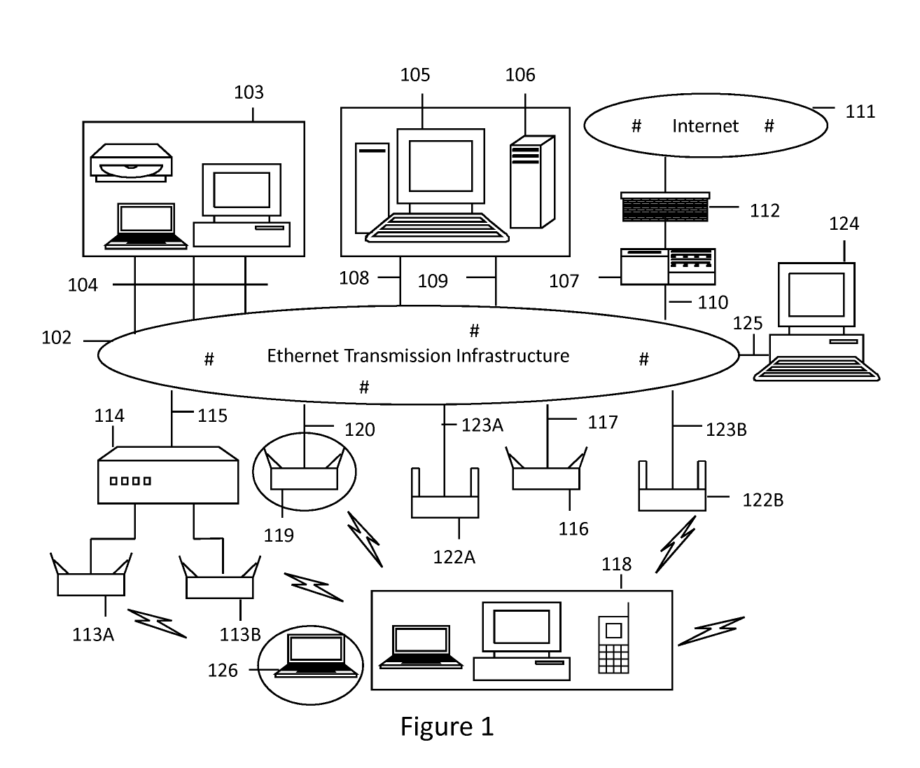

FIG. 1 illustrates a simplified wireless local area network (LAN) that can facilitate the smart mobile devices security monitoring. This diagram is merely an example, which should not unduly limit the scope of the claims herein. Person of ordinary skill in the art would recognize many variations, modifications, and alternatives. In the LAN, a core transmission infrastructure 102 can include various transmission components such as Ethernet cables, hubs, and switches. In a typical deployment, the core transmission infrastructure 102 comprises one or more network segments (subnetworks or subnets). A subnet is typically identified by a network number (e.g., IP number and subnet mask) and the plurality of subnets are interconnected using router device(s). Notably, the plurality of the subnets of the LAN can be geographically distributed (e.g., in offices of a company in different geographic locations). The geographically distributed segments can be interconnected via virtual private network (VPN). In alternative embodiment, a network segment can refer to a virtual LAN (VLAN) segment (e.g., according to IEEE 802.1Q standard).

One or more connection ports (e.g., Ethernet sockets) are provided on each of the segments for connecting various computer systems to the LAN. Thus, one or more end user devices 103 (such as desktop computers, notebook computers, telemetry sensors, etc.) can be connected to LAN via one or more connection ports 104 using wires (e.g., Ethernet cables) or other suitable connection means. Other computer systems that provide specific functionalities and services can also be connected to the LAN. For example, one or more database computers 105 (e.g., computers storing customer accounts, inventory, employee accounts, financial information, etc.) may be connected to the LAN via one or more connection ports 108. Additionally, one or more server computers 106 (computers providing services, such as database access, email storage, HTTP proxy service, DHCP service, SIP service, authentication, network management etc.) may be connected to the LAN via one or more connection ports 109.

In this embodiment, a router 107 can be connected to the LAN via a connection port 110. Router 107 can act as a gateway between the LAN and the Internet 111. Note that a firewall/VPN gateway 112 can be used to connect router 107 to the Internet 111, thereby protecting computer systems in the LAN against hacking attacks from the Internet 111 as well as enabling remote secure access to the LAN.

In this embodiment, a wireless extension of the LAN is also provided. For example, authorized APs 113A and 113B can be connected to the LAN via a switch 114. Switch 114 in turn can be connected to a connection port 115. Switch 114 can assist APs 113A and 113B in performing certain Wi-Fi access procedures (e.g., procedures for authentication, encryption, QoS, mobility, firewall, etc.) as well as provide centralized management functionality for APs 113A and 113B. Note that an authorized AP 116 can also be directly connected to the LAN via a connection port 117. In this case, AP 116 may perform necessary wireless access procedures (such as authentication, encryption, firewall, etc.) itself.

To prevent unauthorized access to the LAN over Wi-Fi, the authorized APs can utilize certain techniques. For example, in accordance with 802.11, a user may be required to carry out an authentication handshake with the AP (or a Wi-Fi switch that resides between the AP and the existing LAN) before being able to connect to the LAN. Examples of such handshake are Wi-Fi Protected Access (WPA and WPA2) based shared key authentication, 802.1× based authentication. The AP can provide additional security measures such as encryption, NAC, and firewall.

In this configuration, one or more end user devices 118 (such as laptop computers, handheld devices, smartphones, tablets, PDAs, etc.) equipped with radio communication capability (called as wireless clients or wireless stations) can wirelessly connect to the LAN via authorized APs 113A, 113B, and 116. Notably, authorized APs connected to the LAN provide wireless connection points on the LAN. Note that Wi-Fi or another appropriate type of wireless network can be used to provide the wireless protocols.

Conventionally, LANs with Wi-Fi extensions are vulnerable to additional security threats such as unauthorized APs (119) which can be connected to the LAN to provide unauthorized Wi-Fi extension (also called as rogue APs), mis-configurions of authorized APs (113A, 113B, 116 A), APs (121) in wireless neighborhood which may attract stations in the LAN to form unauthorized wireless connections (also called as honeypot APs) and like. Security monitoring systems are thus desirable to protect from security threats emerging from these vulnerabilities.

In accordance with an aspect of the invention, a security monitoring system can protect the LAN from different types of unauthorized access (i.e., unauthorized AP or unauthorized station). The security monitoring system (often called as wireless intrusion detection/prevention system) can include one or more RF sensor/detection devices (e.g., sensor devices 122A and 122B, each generically referenced herein as a sniffer 122) disposed within or in a vicinity of a selected geographic region comprising LAN. In an embodiment (shown in FIG. 1), sniffer 122 can be connected to LAN via a connection port (e.g., connection port 123 A/123B). In alternative embodiment, sniffer 122 can be connected to the LAN using a wireless connection.

A sniffer 122 is able to monitor wireless activity in a subset of the selected geographic region. Wireless activity can include any transmission of control, management, or data packets between an AP and one or more wireless stations, or among one or more wireless stations. Wireless activity can even include communication for establishing a wireless connection between an AP and a wireless station (called “association”).

In general, sniffer 122 can listen to a radio channel and listen to transmissions on that channel. In an embodiment, sniffer 122 can cycle through multiple radio channels on which wireless communication could take place. On each radio channel, sniffer 122 can wait and listen for any ongoing transmission. In alternative embodiment, sniffer 122 can operate on multiple radio channels simultaneously.

Whenever a transmission is detected, sniffer 122 can collect and record the relevant information about that transmission. This information can include all or a subset of information gathered from various fields in a captured packet, such as an 802.11 MAC (medium access control) header, an 802.2 LLC (logical link control) header, an IP header, transport protocol (e.g. TCP, UDP, HTTP, RTP etc.) headers, packet size, packet payload, and other fields. In an embodiment, the MAC addresses of the transmitter and the receiver of the packet can be recorded. In alternative embodiment, other information available in the MAC header can also be recorded, such as the packet type, beacon parameters, security settings, SSID, and BSSID. In yet alternative embodiment, a receive signal strength indicator (RSSI) associated with the captured packet can also be recorded. Other information such as the day and the time the transmission was detected can also be recorded.

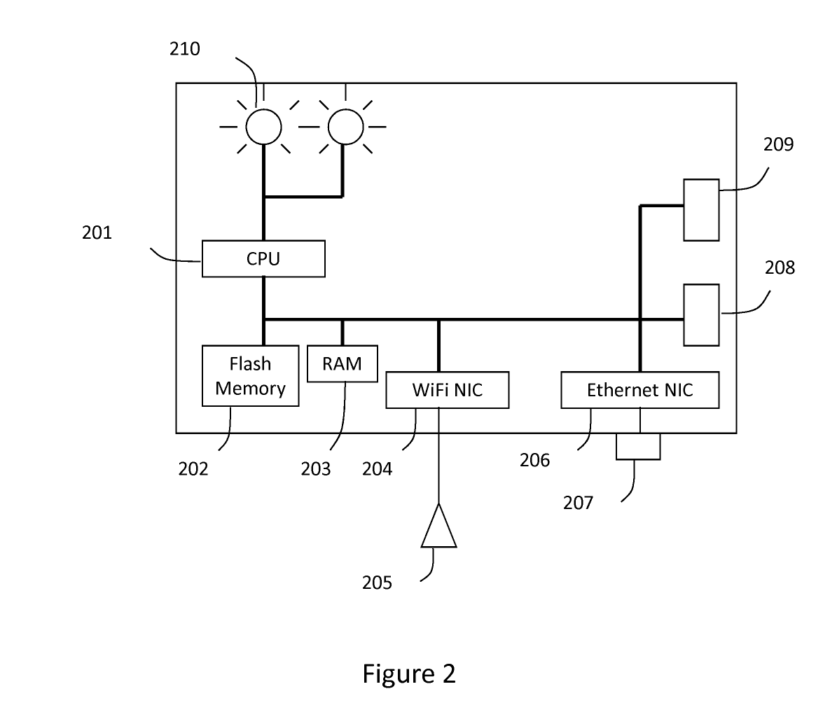

In a preferred embodiment, sniffer 122 can be any suitable receiving device capable of detecting wireless activity. An exemplary hardware diagram of the sniffer is shown in FIG. 2. This diagram is merely an example, which should not unduly limit the scope of the claims herein. One of ordinary skill in the art would recognize many variations, alternatives, and modifications. As shown, in order to provide the desired detection and recording functionality, sniffer 122 can have a processor 201, a flash memory 202 where the software code for sniffer functionality resides, a RAM 203 which serves as volatile memory during program execution, one or more 802.11a/b/g/n/ac wireless network interface cards (NICs) 204 which perform radio and wireless MAC layer functionality, one or more (i.e., for radio diversity) of dual-band (i.e., for transmission detection in both the 2.4 GHz and 5 GHz radio frequency spectrums) antennas 205 coupled to the wireless NICs, an Ethernet NIC 206 which performs Ethernet physical and MAC layer functions, an Ethernet jack 207 such as RJ-45 socket coupled to the Ethernet NIC for connecting the sniffer device to wired LAN with optional power over Ethernet or POE, a serial port 208 which can be used to flash/configure/troubleshoot the sniffer device, and a power input. One or more light emitting diodes (LEDs) 209 can be provided on the sniffer device to convey visual indications (such as device working properly, error condition, unauthorized wireless activity alert, and so on).

Sniffer 122 can be built using a hardware platform similar to that used to build an AP with appropriate software to implement the sniffer functionality. Sniffer 122 could also be provided with radio transmit interface, thereby allowing sniffer 122 to generate interference with a suspected intruder's transmission. For example, a sniffer can use one of the wireless DoS (Denial of Service) techniques like spoofed de-authentication, virtual jamming, AP flooding, etc. to block the communication attempts of the intruder device (i.e., intrusion prevention). The radio transmit interface could also be used by the sniffer 122 for active probing which involves transmission of test signals.

In alternative embodiment, the sniffer 122 and the AP can share the radio interface (204). For example, the radio interface can stay tuned to a wireless channel most of the time where AP traffic is to be supported. The interface tunes to other channels to perform traffic sniffing on those channels, briefly interrupting the traffic channel.

In yet alternative embodiment, the sniffer remains tuned to the channel where AP traffic is to be supported. The sniffing function can then be performed on the traffic channel.

The sniffer 122 is also capable of performing traffic sniffing on its wired interface (206). For example, broadcast and multicast packets that are transmitted by wireless clients and transferred through the AP to wired side of the network, e.g., to subnetwork or to VLAN, can be detected by the sniffer 122 whose wired interface is connected into a switch port belonging to that subnetwork or VLAN. This has the advantage that the contents of such packets can be decoded by the sniffer even if such packets are encrypted on the wireless side, since packets are typically decrypted and transferred to the wired side of the network by the AP in unencrypted form. Examples of such broadcast/multicast packets include multicast DNS (mDNS), DHCP, NETBIOS, LLMNR, etc.

A sniffer 122 can be spatially disposed at an appropriate location in the selected geographic region by using heuristics, strategy, and/or calculated guesses. In accordance with one aspect of the invention, an RF (radio frequency) planning tool can be used to determine deployment location for sniffer 122.

A security monitoring system server 124 can be coupled to the LAN using a connection port 125. Alternatively, the server can be hosted in the Internet (hosted in the cloud). In an embodiment, each sniffer 122 can convey its information about detected wireless activity to server 124 (i.e., over one or more computer networks). Server 124 can then analyze that information, store the results of that analysis, and process the results. The server may also perform functions such as accepting system and/or policy configuration from user and triggering/delivering indications to user. For example, these indications can be in the form of alerts which may be displayed on a computer screen or may be delivered via email, SNMP, SMS, etc. In a specific embodiment, sniffer 122 may filter and/or summarize the channel scan data before conveying it to server 124.

Sniffer 122 can also advantageously receive configuration information from server 124. This configuration information can include, for example, the operating system software code, the operation parameters (e.g. frequency spectrum and radio channels to be scanned), the types of wireless activities to be detected, and the identity information associated with any authorized wireless device. Sniffer 122 may also receive specific instructions from server 124, e.g. tuning to specific radio channel or detecting transmission of specific packet on a radio channel. The server can also process and store wireless monitoring data received from sniffers for analysis and review. The administrator can log into the server for reviewing and acting on alerts, policy configurations, etc.

Additional details on the security monitoring system can also be found in the U.S. Pat. No. 7,002,943 to Bhagwat et al., entitled “Method and System for Monitoring a Selected Region of an Airspace Associated with Local Area Networks of Computing Devices”, issued on Feb. 21, 2006, the U.S. Pat. No. 7,536,723 to Bhagwat et al., entitled “Automated Method and System for Monitoring Local Area Computer Networks for Unauthorized Wireless Access”, issued on May 19, 2009, and the U.S. Pat. No. 7,339,914 to Bhagwat et al., entitled “Automated Sniffer Apparatus and Method for Monitoring Computer Systems for Unauthorized Access”, issued on Mar. 4, 2008; each of which is herein incorporated by reference.

The present invention contemplates utilizing the security monitoring system comprising the sniffers 122 to provide protection from the new and recent security threats arising out of the proliferation and consumerization of the smart mobile devices. In an aspect, the present invention facilitates specifying the smart mobile devices usage policy on the office premises. In another aspect, the present invention facilitates detecting the smart mobile devices connecting into the enterprise network (e.g., over Wi-Fi) and enforcing the specified usage policy. In yet another aspect, the present invention facilitates performing certain actions on devices found to violate the usage policy.

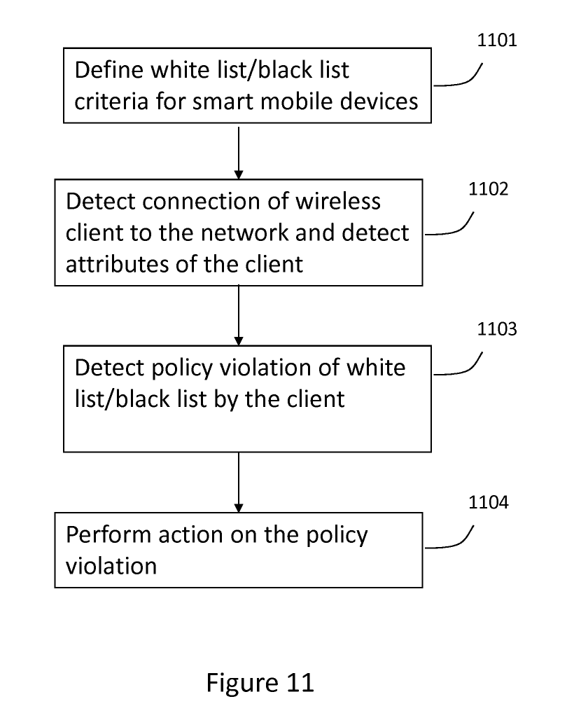

An exemplary flow of steps in a method for smart mobile devices monitoring according to an embodiment of the present invention is illustrated in FIG. 11. This diagram is merely an example, which should not unduly limit the scope of the claims herein. One of ordinary skill in the art would recognize many variations, alternatives, and modifications. Note that the term smart mobile device is used here to refer to smartphones, tablets, PDAs, e-readers, and other such devices. At step 1101, the method permits defining white listing criteria for the smart mobile device use in the enterprise network. That is, the smart mobile devices which fall within the white listing criteria may be allowed to connect to the enterprise network (e.g., over Wi-Fi). White listing criteria can be without limitation certain permutations and combinations of the following exemplary factors:

Permit smart mobile devices to connect to the enterprise network at one or more specific locations on the office premises.

Permit smart mobile devices to connect to the enterprise network on one or more specific networks (e.g., SSIDs/subnetworks/VLANs) on the office premises.

Permit smart mobile devices from specific vendors (e.g., Apple, Samsung, RIM, HTC, Nokia, etc.) to connect to the enterprise network.

Permit smart mobile devices with specific operating system platforms (e.g., Apple iOS, Google Android, RIM BlackBerry, Microsoft Windows, etc.) to connect to the enterprise network.

Permit smart mobile devices with specific identities (e.g., MAC address) to connect to the enterprise network.

Permit specific users to connect smart mobile devices to the enterprise network.

Permit smart mobile devices of specific formats (e.g., phone, tablet, e-reader, etc.) to connect to the enterprise network.

Permit smart mobile devices which run specific security agents on them (e.g., mobile device management (MDM) agents) to connect to the enterprise network. MDM agents are typically deployed on the devices to perform functions such as anti-virus, remote wiping, connection policy enforcement, installation and maintenance of applications (apps), remote configuration of network access parameters, etc.

In alternative embodiment, at step 1101, the method permits defining black listing criteria for the smart mobile device use in the enterprise network, using factors similar to those described above for the white listing policy.

Moreover, at step 1102, the method detects wireless clients connecting into the enterprise network and collects various attributes associated with them. For example, the detection can be based upon packet transmission between the wireless station and the AP (e.g., authorized AP 116, 113, etc.), detected by the sniffer 122 on the wireless medium. As another example, the detection can be based on the wireless station's traffic that is transferred by the AP to the wire side of the network which can be detected by the wired interface of the sniffer 122. When such connection is detected, various attributes associated with the wireless client are collected. The exemplary attributes which can facilitate enforcing the specified smart devices usage policy are without limitation as follows:

Location of the Device:

The location of the device can be determined based upon one or more sniffers which detect the strongest signal strength (RSSI) from the device. Alternately, the location of the device can be inferred from the location of the AP to which it is connected.

Network where the Device Connects:

Wireless network to which the device connects can be determined from the SSID or the BSSID of the AP to which the device connects. Many of the APs support multiple SSIDs with each SSID mapped to a specific subnetwork/VLAN on the wire side. The subnetwork/VLAN to which a device connects can be determined by the subnetwork/VLAN associated with the particular SSID. The network can also be determined based upon the subnetwork which contains the wired interface of the sniffer which detects packets from the device on the wired side of the network.

MAC Address of the Device:

MAC address of the device can be found by monitoring the link layer traffic transmitted/received by the device. In an embodiment, MAC address can be used to determine the vendor of the device. For example, according to the IEEE convention for MAC address allocation, the first 3 bytes of the MAC address are called OUI (Organization Unique Identifier) and they can be used to identify vendor that supplies or produces the device.

User of the Device:

The user of the device can be determined from certain application level data that is transmitted by the device. For example, multicast DNS (mDNS) packets contain information about the user of the Apple smartphone. In alternative embodiment, user of the device can also be determined by monitoring certain wireless messages, such as for example, PEAP (Protected Extensible Authentication Protocol) EAP Identity Response message which contains user identifier.

Device Type:

Type of the device can be inferred from certain packets that are transmitted by applications that are characteristic of the manufacturer of the device or the Operating System (OS) on the device. For example, NETBIOS or LLMNR (Link Level Multicast Name Resolution) packets that are transmitted by the Microsoft Windows platforms, mDNS (multicast Domain Name Service) packets that are transmitted by the Apple devices and applications. The device type is preferably characterized by one or both of:

The device hardware model: iPhone, iPad, and iPod for Apple, BlackBerry phone, PlayBook for RIM, smarphone and tablet for Android, etc. are examples of hardware models of smart devices. Other examples of hardware models can include model identifier of the device (e.g., iPad3, BlackBerry 9810, etc.), model name of the device (e.g., Samsung Galaxy Tab, HTC Desire, etc.), etc.

The device operating system (OS): Examples of popular smart device OS are iOS from Apple, Android from Google, BlackBerry from RIM, Symbian, Windows Mobile from Microsoft, etc. In certain embodiments, the OS version (e.g., iOS-3, iOS-4, iOS-5, Android 2.0, Android version 3, etc.) is also used to characterize the device type.

Presence of MDM Agent on the Device:

The presence of an MDM agent can be determined based on certain signature packets that the MDM agent transmits. Alternatively, it can be determined based upon the MDM agent registering itself with certain server (e.g., the Server 124) when the device connects to the network. Yet alternatively, the presence of the MDM agent can be determined by querying the MDM Server which maintains the list of devices (e.g., MAC addresses) that are managed by it.

Based upon the specified policy and the detected attributes, the method at step 1103 can determine if the wireless client connecting into the enterprise network causes a policy violation. If the policy violation is detected, the method can trigger an alarm to the administrator.

In an embodiment, the policy violation alarm is generated when a device, which falls outside of the white list (or within a black list), connecting to the enterprise network is detected. Raising alarm after the connection facilitates reducing false alarms from devices which may be in the vicinity of the enterprise network, but do not connect to the network, for example, employee's personal device which does not connect to the office network, devices on the neighborhood premises which do not connect to the monitored office network, etc. In a specific embodiment, the smart device policy is applied in conjunction with the client auto-classification policy (for example, such as one described in the U.S. Pat. No. 7,710,933 to Sundaralingam et al., entitled “Method and System for Classification of Wireless Devices in Local Area Computer Networks”, issued on May 4, 2010; which is herein incorporated by reference). In this embodiment, wireless clients are identified as authorized clients, based on their connections to the authorized access points. Further, if such authorized client is identified as a smart mobile device based on the techniques of the present invention, the appropriate smart mobile device policy is applied to it.

The method at step 1104 can facilitate performing certain actions on the policy violation. For example, an alert/alarm can be raised to indicate the policy violation to the administrator. The administrator can initiate connection blocking/disruption on the policy violating connection. Alternately, policies can be defined to automatically block/disrupt such policy violating devices from connecting to the network. Conventionally, techniques such as forced de-authentication, switch port blocking, ARP poisoning, etc. have been known to inflict such blocking/disruption on the policy violating connection.

Depending upon the embodiment, the administrator can act on the alarm in one or more of the following ways:

Allow the device to connect,

Block the device from connecting to the enterprise network by initiating over the air or over the wire blocking process on it (for example, using techniques such as those described in the U.S. Pat. No. 7,333,800 to Gopinath, entitled “Method and System for Scheduling of Sensor Functions for Monitoring of Wireless Communication Activity”, issued on Feb. 19, 2008, and the U.S. Pat. No. 7,558,253 to Rawat et al., entitled “Method and System for Disrupting Undesirable Wireless Communication of Devices in Computer Networks”, issued on Jul. 7, 2009; each of which is herein incorporated by reference),

Flag the device for automatic blocking on subsequent connection attempts,

Locate the device using RSSI based triangulation performed by sniffers 122, etc. (for example, using techniques such as those described in the U.S. Pat. No. 7,406,320 to Kumar et al., entitled “Method and System for Location Estimation in Wireless Networks”, issued on Jul. 29, 2008; which is herein incorporated by reference).

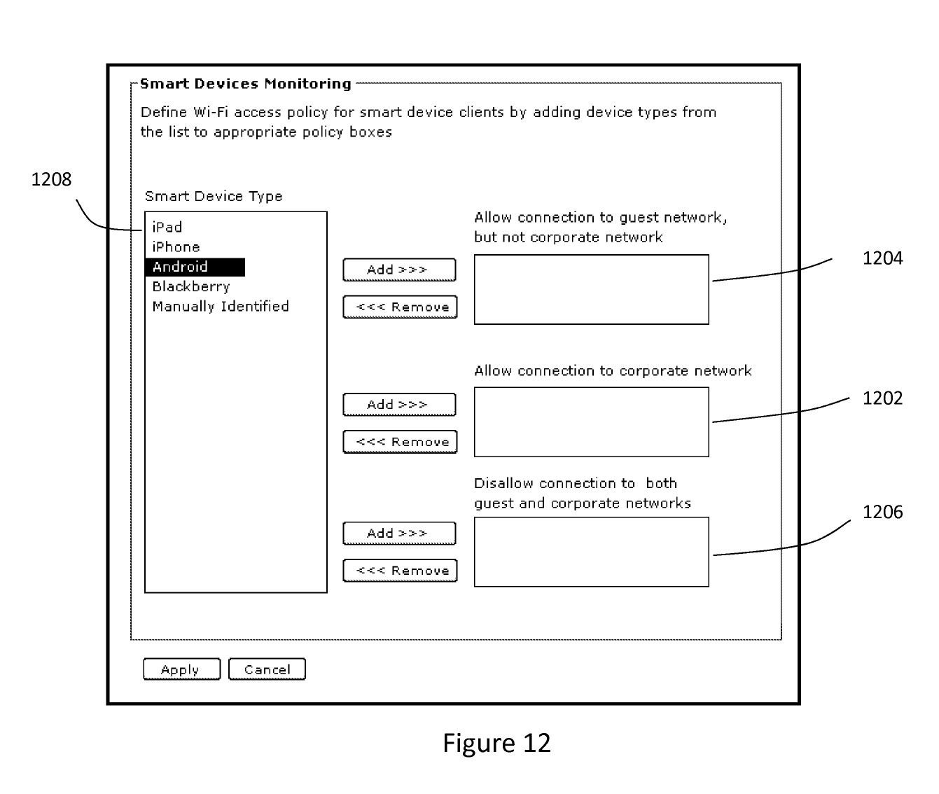

An exemplary computer screenshot that facilitates specification of certain smart mobile device policy in corporate wireless local area networks is shown in FIG. 12. The screenshot shown in the figure is illustrative only and should not unduly limit the scope of the invention. Person of ordinary skill in the art would recognize many variations, modifications, and alternatives. As shown, the screenshot provides following policy options: a) allow the smart mobile devices to connect to the corporate wireless network (1202), b) allow the smart mobile devices to connect to the guest wireless network, but not the corporate wireless network (1204) (for example, several organizations deploy a wireless network for guests, which is logically separated from the corporate network using different different SSIDs, different subnetworks, different VLANs, etc. The guest wireless network can be typically used for the Internet access, but access to the corporate assets is typically restricted from the guest network.), c) disallow smart mobile devices to connect to both guest and corporate wireless networks (1206).

Moreover, as shown in FIG. 12, the policy also can also facilitate specifying the types of the smart mobile devices for which the specific policies are to be applied. For example, by adding the type of the device from the panel 1208 into the boxes 1202, 1204 or 1206, the corresponding policy can be enforced on the selected device type. As merely an example, the BlackBerry devices may be allowed to connect to the corporate Wi-Fi network (e.g., by adding BlackBerry type into box 1202), while iPhones and iPads may be disallowed to connect to the corporate Wi-Fi network but allowed to connect to the corporate guest network (e.g., by adding iPhone and iPad types into box 1204). This could for example be because the corporate IT may have given out BlackBerry devices to employees, but iPhone and iPad are considered personal employee devices. Advantageously, the present invention can facilitate blocking personal mobile devices even when users use (e.g., use against the policy) the enterprise network credentials (e.g., their usernames and passwords on the IT assigned devices) on their personal mobile devices to connect the personal devices to the enterprise wireless networks.

In order to identify a smart mobile device or a type of the smart mobile device to facilitate the policy enforcement, the present invention utilizes certain signatures that can be detected in the packets transmitted by the device in the wired network and/or on the wireless link. In an embodiment, the signatures can correspond to the values of certain fields in the transmitted packets or information derived thereof. In alternative embodiment, it can be a specific protocol behavior. In yet alternative embodiment, it can be timing information associated with transmissions. In an embodiment, the signature can be a characteristic of the device hardware. In alternative embodiment, the signature can be a characteristic of the device firmware. In yet alternative embodiment, the signature can be a characteristic of the device operating system (OS). In further alternative embodiment, the signature can be a characteristic of the application running on the device.

The wireless devices from different vendors can produce different signatures in the transmitted packets, although they implement similar protocol standards (e.g., TCP/IP protocol suite, IEEE 802.11 wireless LAN standard). Further, different models of the wireless devices provided by the same vendor can also produce different signatures. These signatures can include, but not limited to:

Certain packets that are transmitted by applications that are characteristic to the manufacturer of the device or the Operating System (OS) on the device. For example, NETBIOS or LLMNR (Link Level Multicast Name Resolution) packets that are typically transmitted by the Microsoft Windows platforms, mDNS (multicast Domain Name Service) packets that are typically transmitted by the Apple devices and applications.

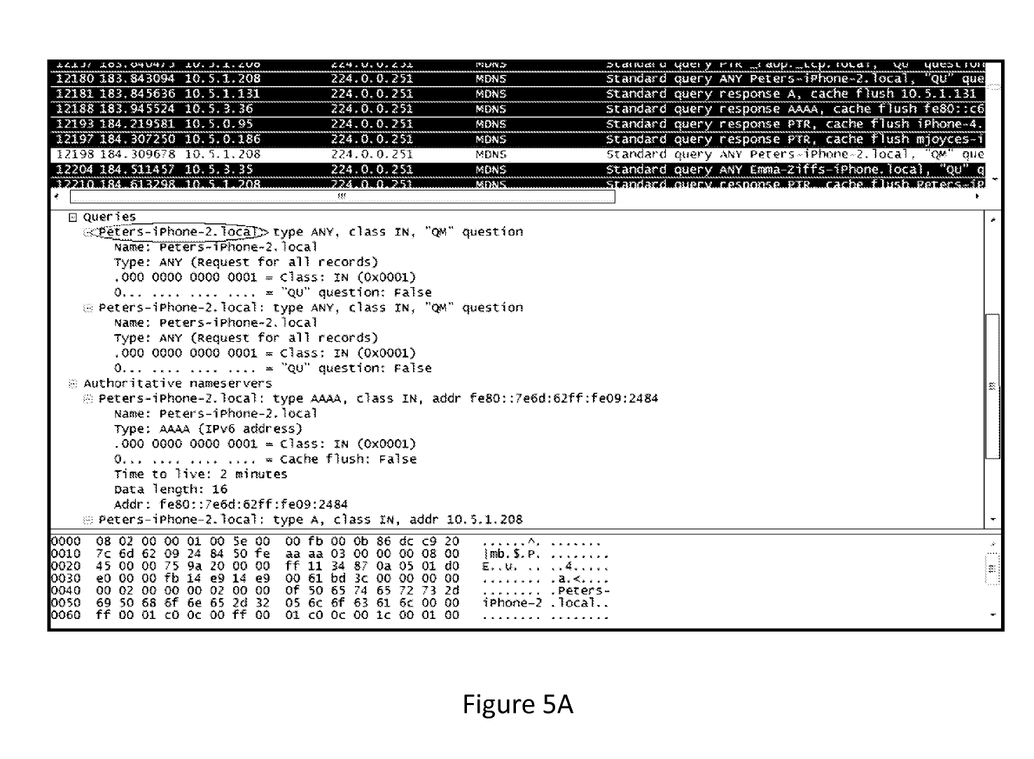

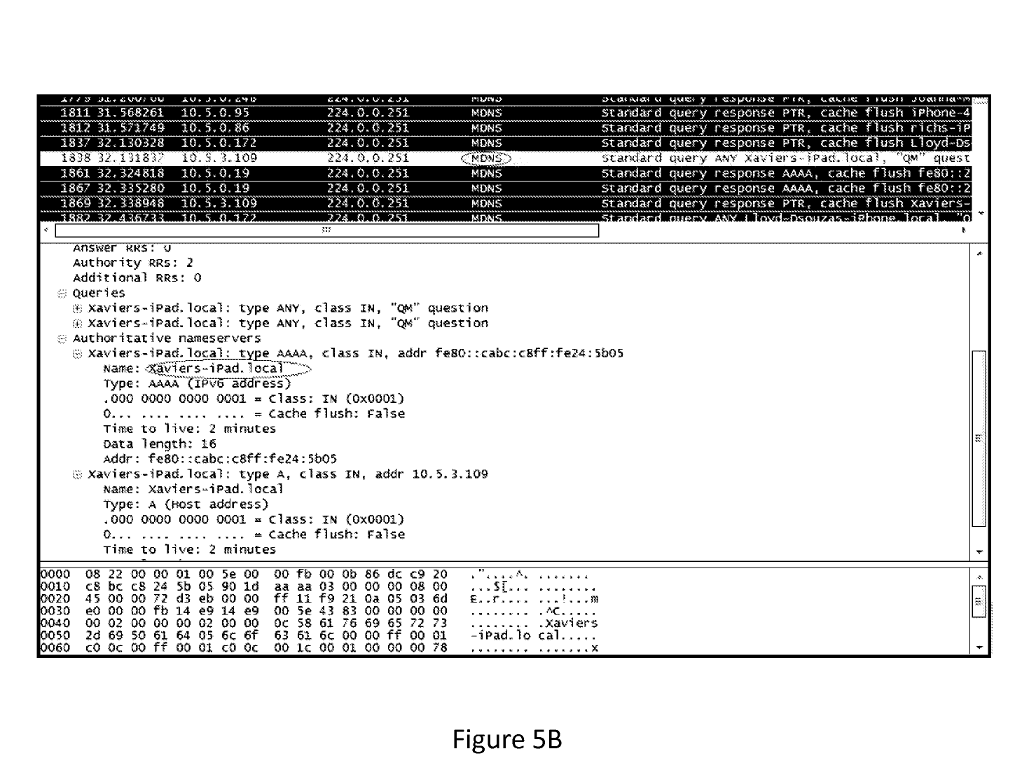

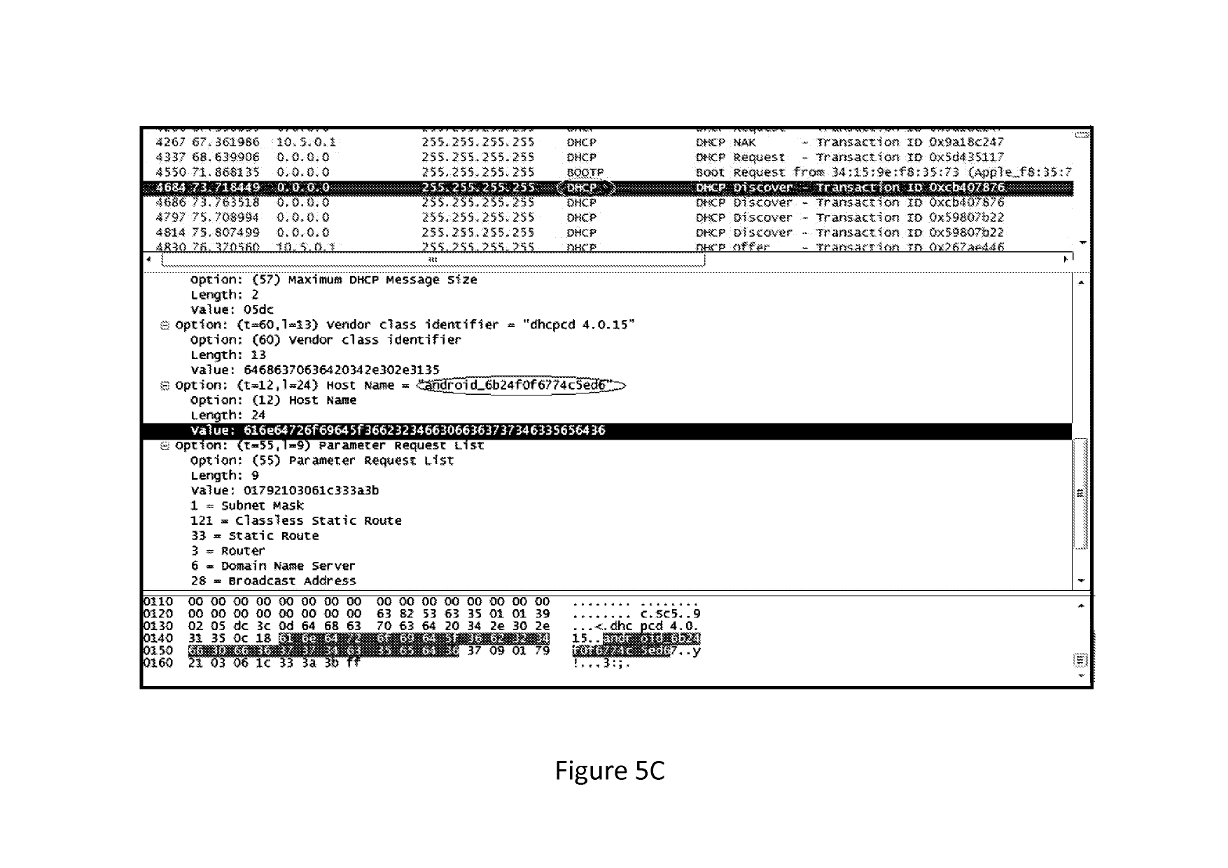

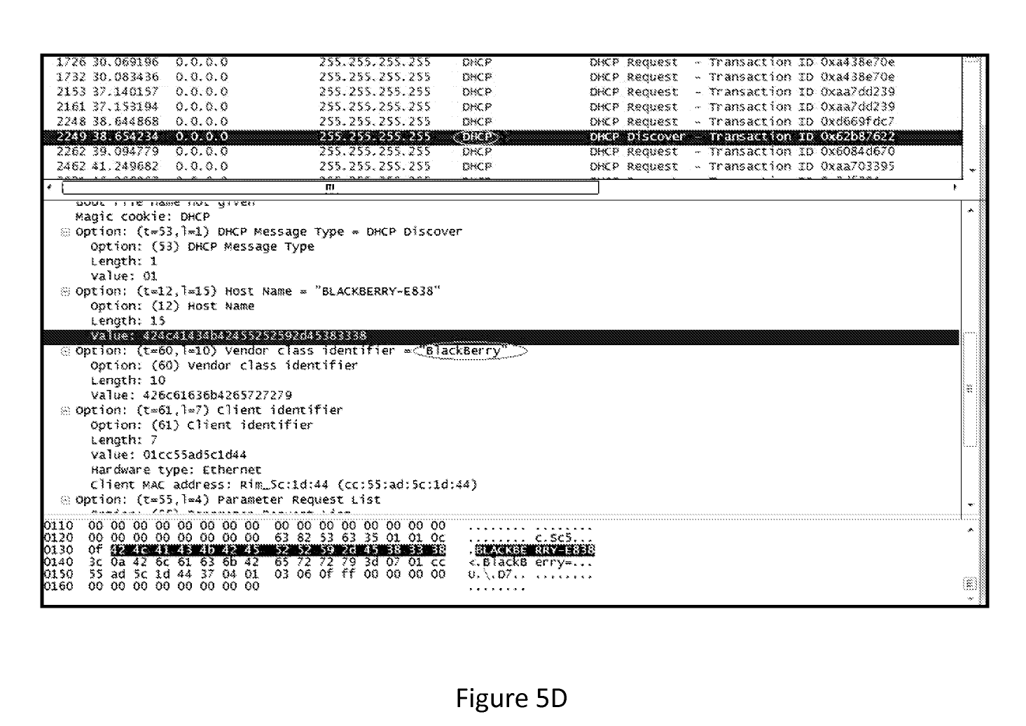

Hardware model of the device as advertised by the device in certain packets. For example, the mDNS packets may indicate whether a device is iPhone-1, iPhone-2, iPhone-3, iPhone-4, iPad or macbook. For example, FIG. 5A and FIG. 5B illustrate certain expanded views of the mDNS packets showing device identities in them as iPhone-2 and iPad, respectively.

Device platform identifier. For example, “Host Name” field or other fields in the DHCP packet can often include identifier for the device OS platform. For example, FIG. 5C and FIG. 5D illustrate certain expanded views of the DHCP Discover packets showing device platform identities in them as Android and BlackBerry, respectively.

User or owner of the device as advertised by the device in certain packets. For example, the mDNS packets may indicate the identity of the person logged into the device (for example, “peters” as seen in FIG. 5A).

Mutlicast destination address used in the transmitted packets can itself act as a signature for the transmitter device. For example, IPv4 multicast address (01:00:5e:00:00:fb) and IPv6 multicast address (::ff02::fb) are typically used by the Apple devices.

Length of packets transmitted can also be used as a unique signature for the transmitter. For example, mDNS packets of length 94 bytes are typically transmitted by the Apple devices. Similarly, NETBIOS packets of length 110 bytes are typically transmitted by the Windows devices. When encrypted versions of these packets are detected on the wireless link, the size increase due to encryption can be precisely estimated. When these packets are transferred through the AP from wireless to wire side, these packets are typically in unencrypted form on the wire side.

Vendor specific information found in packets such as probe request, association request, etc.

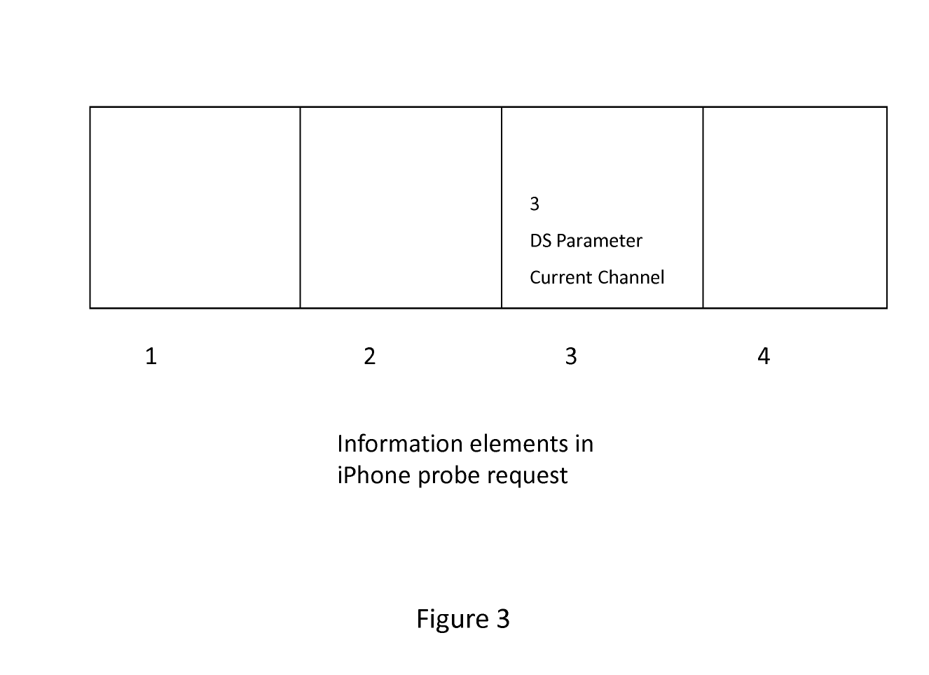

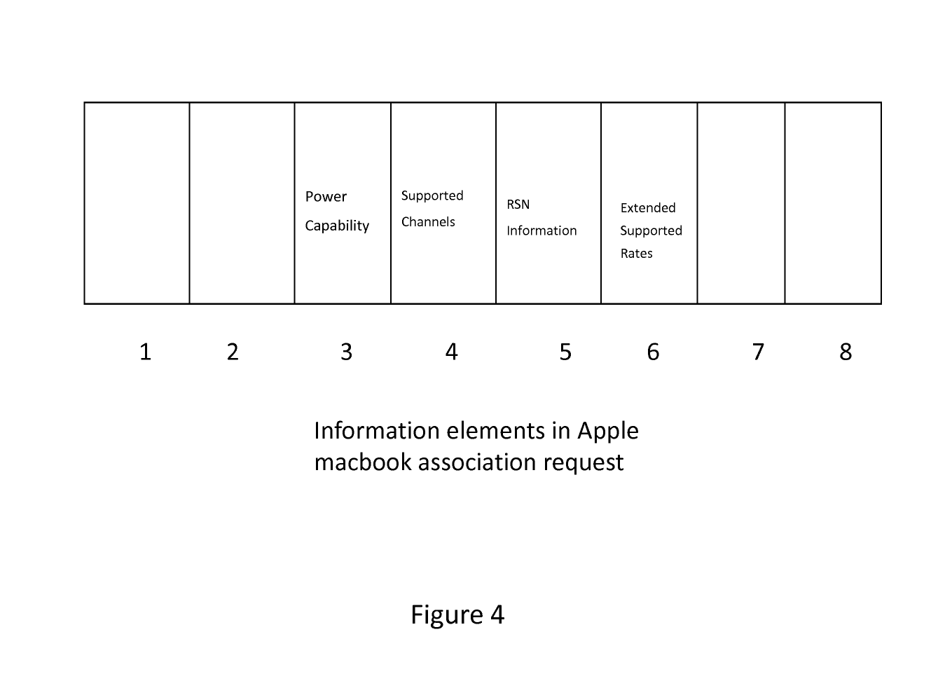

Total number of information elements and/or their types and values, transmitted in certain wireless packets (e.g., probe request, association request). For example, Apple iPhone-1, iPhone-2 and iPhone-3 models typically transmit a “DS Parameter Current Channel” information element in their probe requests (as illustrated in FIG. 3). Similarly, Apple MacBooks typically transmit 8 Information Elements (IEs) in their association request packets. Further, such association request packet contains some peculiar IEs (Information Elements) such as power capability, supported channels, RSN information, and extended supported rates, that too in certain peculiar order (as illustrated in FIG. 4).

Packet Transmission Rate. For example, Nokia N9000 smartphone typically transmits 802.11 management frames (e.g., authentication request, association request) at 6 Mbps rate. Further, devices can differ with respect to the set of transmission rates that they support.

Contents of the HTTP requests made by the client. For example, the “User Agent” field of the HTTP packet may contain the information about the OS/browser from which it may be possible to identify the OS and/or the manufacturer of the device. Another example is that Apple devices try to connect to “mother ship”—Apple website (http://www.apple.com) during startup. Certain signatures of this type may require the sniffer to be in the data path of the client. This can be achieved rather easily if the sniffer functionality is combined with the access point functionality in a single device. Alternatively, this can be achieved if the access point itself is configured to detect smart device signatures.

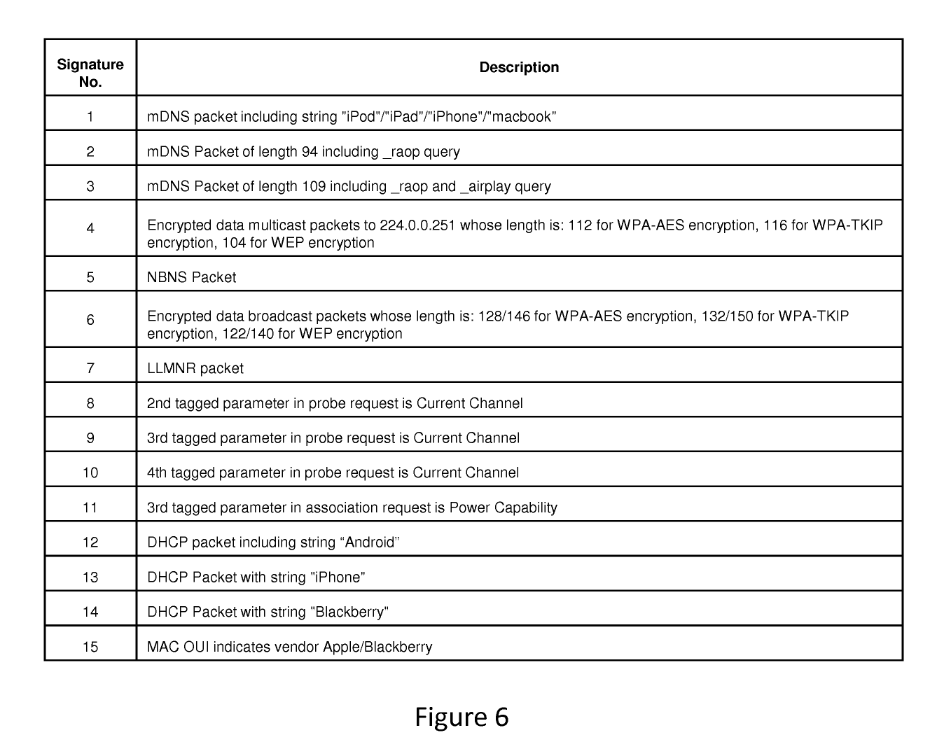

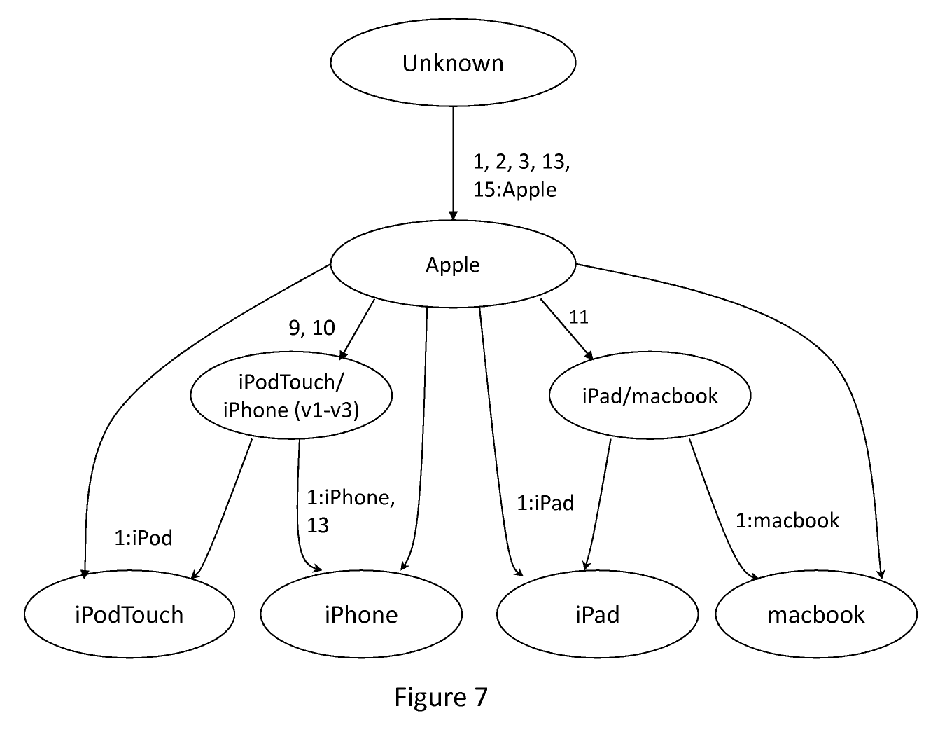

Reference is now drawn to FIG. 7 for illustration of identifying Apple smart mobile devices and their types using packet based signatures listed in FIG. 6, according to an embodiment of the invention. The signatures listed in FIG. 6 and the diagram in FIG. 7, are merely examples, which should not unduly limit the scope of the claims herein. Person of ordinary skill in the art would recognize many variations, modifications, and alternatives. As shown in FIG. 7, the device can be initially tagged as Unknown type. Based on the signatures detected in the packets transmitted by the device (as indicated by the signature number(s) next to the state transition arcs), the device can then get classified as of specific type.

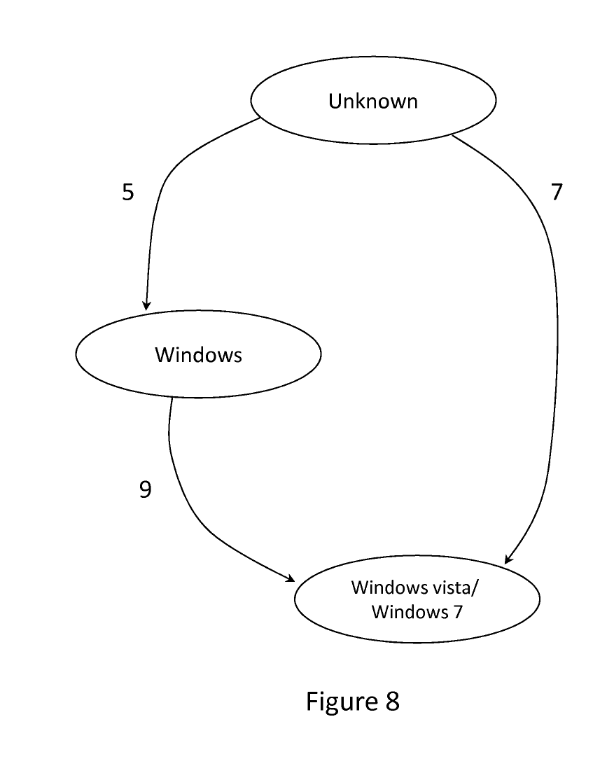

Reference is now drawn to FIG. 8 for illustration of identifying Windows smart mobile devices and their types using packet based signatures listed in FIG. 6, according to an embodiment of the invention. The diagram in FIG. 8 is merely an example, which should not unduly limit the scope of the claims herein. Person of ordinary skill in the art would recognize many variations, modifications, and alternatives.

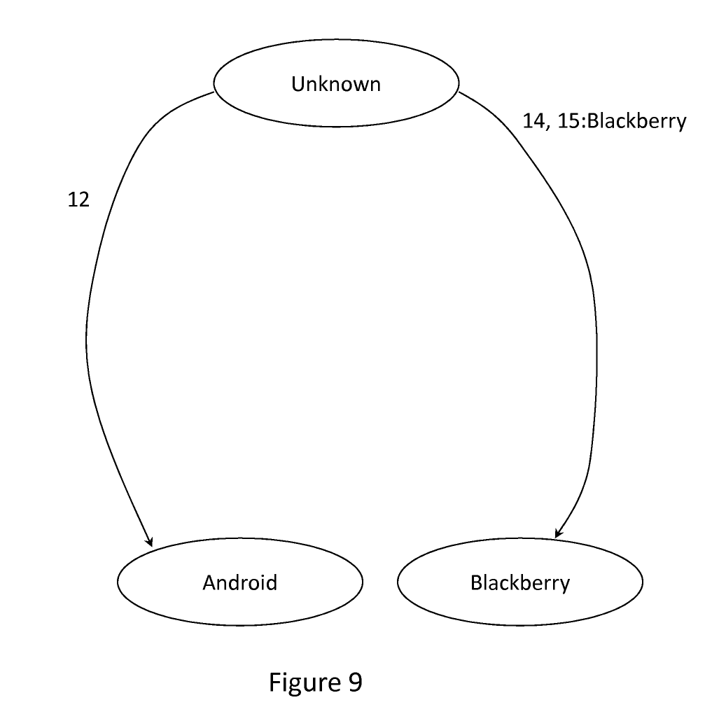

Reference is now drawn to FIG. 9 for illustration of identifying BlackBerry and Android smart mobile devices and their types using packet based signatures listed in FIG. 6, according to an embodiment of the invention. The diagram in FIG. 9 is merely an example, which should not unduly limit the scope of the claims herein. Person of ordinary skill in the art would recognize many variations, modifications, and alternatives.

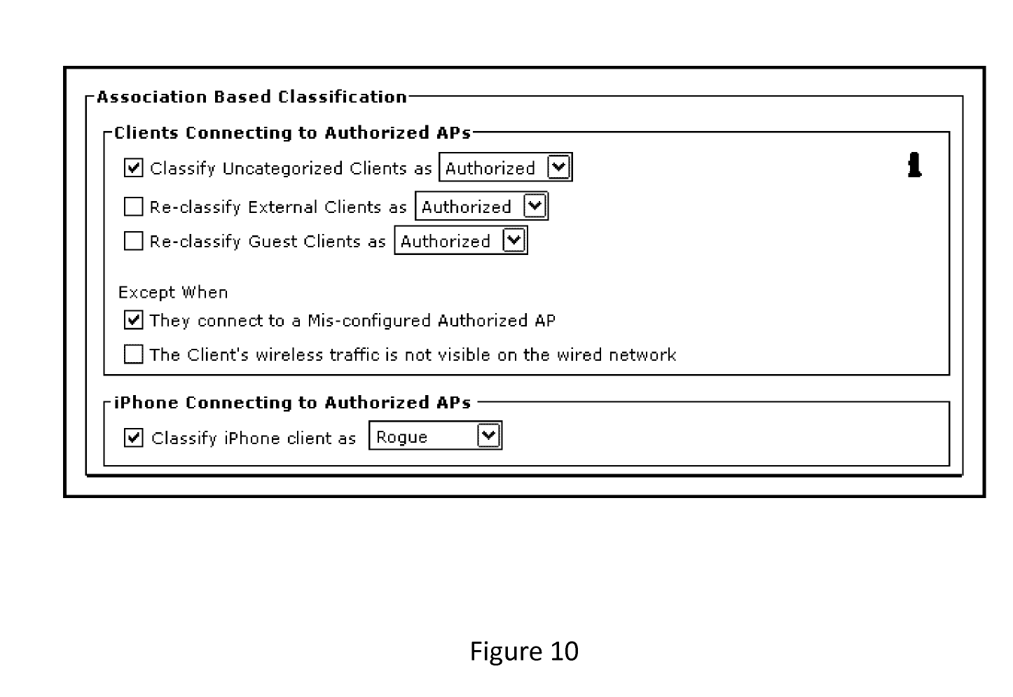

In an embodiment, the invention can facilitate identifying certain smart mobile device formats such as smartphones in order to apply location based wireless network access policy. For example (as illustrated in FIG. 10), automatically classify smartphones connecting to an authorized AP at a given location as authorized (e.g., iPhone is white listed). At certain other locations, such smart phones can be classified as unauthorized or rogue devices (e.g., iPhone is black listed). Further, automatic blocking or prevention can be enabled based upon the classification to prevent such clients from using the Wi-Fi network (e.g., prevent blacklisted devices from connecting to network). Note that the diagram in FIG. 10 is merely an example, which should not unduly limit the scope of the claims herein. Person of ordinary skill in the art would recognize many variations, modifications, and alternatives.

In an embodiment, this invention can be used in a wireless sniffer. In alternative embodiment, it can be used in an AP to block access to wireless network for certain smart mobile devices such as personal smartphones and tablets, or alternately provide restricted network access (e.g., to a “walled garden” such as specific VLAN, specific websites, specific IP addresses, specific applications, etc.) for certain smart mobile devices.

In yet alternative embodiment, this invention can be used to determine Wi-Fi clients that spoof or change their MAC addresses to bypass security policies. As merely an example, if a Windows laptop spoofs MAC address of Apple iPad, it is possible to tell that the packets transmitted by the laptop do not match up with signature of iPad and hence it is possible to infer MAC spoofing attempt.

In a specific embodiment, the present invention provides a system for policy based smart phone monitoring in wireless networks. The system comprises a processor unit, a radio communication interface, and a computer readable medium storing computer code. The computer code comprises a first portion of the code for setting wireless network access policy for wireless devices, the wireless access policy being based at least upon a type of a wireless device. The type of the wireless device can be characterized by at least a device hardware type or at least a device operating system type. The computer code comprises a second portion of the code for ascertaining a connection of a first wireless device to the wireless network. Moreover, the computer code comprises a third portion of the code for determining the type of the first wireless device based at least upon one or more fields in one or more packets transmitted by the first wireless device and received by the radio communication interface, wherein the one or more fields contain information which is characteristic of the type of the first wireless device. The computer code also comprises a fourth portion of the code for ascertaining violation of the wireless access policy based at least upon the determined type of the first wireless device, and a fifth portion of the code for responding to the violation of the wireless access policy.

In an alternative specific embodiment, the present invention provides a system for policy based smart phone monitoring in wireless networks. The system comprises a processor unit, a wired communication interface, and, a computer readable medium storing computer code. The computer code comprises a first portion of the code for setting wireless network access policy for wireless devices, the wireless access policy being based at least upon a type of a wireless device. The type of the wireless device can be characterized by at least a device hardware type or at least a device operating system type. The computer code comprises a second portion of the code for ascertaining a connection of a first wireless device to the wireless network. Moreover, the computer code comprise a third portion of the code for determining the type of the first wireless device based at least upon one or more fields in one or more packets transmitted by the first wireless device and received by the wired communication interface, wherein the one or more fields contain information which is characteristic of the type of the first wireless device. The computer code also comprise a fourth portion of the code for ascertaining violation of the wireless access policy based at least upon the determined type of the first wireless device, and a fifth portion of the code for responding to the violation of the wireless access policy.

In a specific embodiment, the wireless access policy comprises a white listing policy. In this embodiment, the policy violation comprises connection of a smart mobile device outside of the white list. For example, the smart mobile device white list policy can state that only Apple iPad devices are allowed. Then in this embodiment, if an Apple iPhone connects to the enterprise network, it will be called as a policy violation. Also as another example, if Android phone or Android tablet connects to the enterprise network, it will be called as policy violation. Notably when a user connects using the Apple iPad, that connection is allowed, but when the same user connects using the Adroid phone or tablet (e.g., using the same network username and password used on the authorized iPad), that connection can be blocked.

In an alternative specific embodiment, the wireless access policy comprises a black listing policy. In this embodiment, the policy violation comprises connection of a smart mobile device inside of the black list. For example, the smart device black list policy can state that all Apple and Android devices are banned from connecting to the network. This could for example facilitate keeping personal mobile devices out of the network, for example, if the organization has standardized on BlackBerry for the employee mobile devices. Then in this embodiment, if a BlackBerry phone connects to the enterprise network, it will not be called a policy violation. But if an Android phone connects, it will be called as a policy violation. Notably when a user connects using the BlackBerry phone it is allowed, while when the same user connects using the Adroid phone (e.g., using the same network username and password used on the authorized BlackBerry), that connection can be blocked.

In specific embodiments, the device OS can be selected from the group consisting of iOS, Android OS, Blackberry OS, and Microsoft OS. For example, iOS can be detected based on the mDNS packets. Also as example, Android OS can be detected based on the DHCP packets (e.g., hostname field in the DHCP packets transmitted by Android devices often contains the string which includes “android” in it, see for example FIG. 5C). Also as another example, Blackberry OS can be detected based on the DHCP packets (e.g., vendor class identifier field in DHCP packets transmitted by Blackberry devices often contains the string which includes “blackberry” in it, see for example FIG. 5D). As yet another example, Microsoft OS can be detected based on the NETBIOS and/or LLMNR packets, which are characteristic of the Microsoft OS. Other appropriate fields in other appropriate packets can also be used to detect the operating system type of the device.

Alternatively, certain OS types such as iOS and BlackBerry can also be inferred based upon vendor OUI in the MAC address of the device; since these OS are typically provided by well known and preferably unique vendors, namely, Apple and RIM, respectively.

In specific embodiments, the device hardware type can be selected from the group consisting of iPhone-1, iPhone-2, iPhone-3, iPhone-4, iPad, and MacBook. For example, mDNS packet transmitted by the Apple device can include such hardware type identifier (see for example FIGS. 5A and 5B).

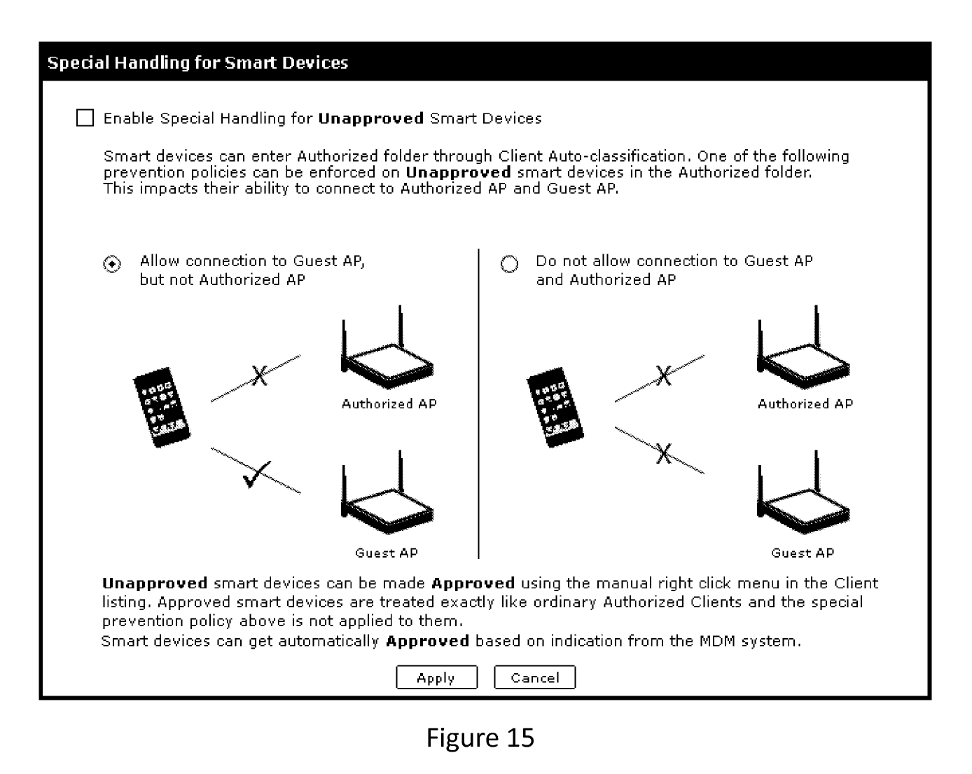

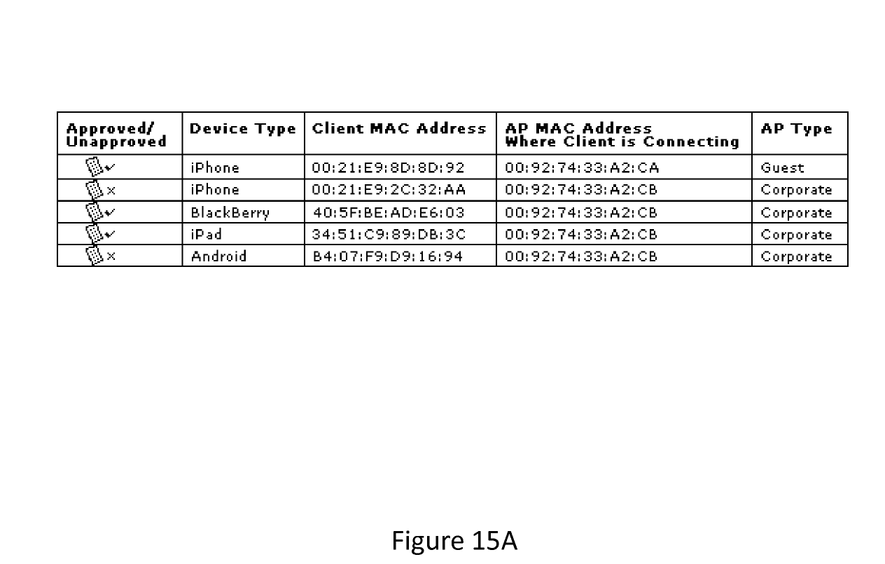

In yet an alternative embodiment, the policy may specify actions to be performed for a wireless client that is any smart mobile device, i.e., smart mobile devices of all types. An exemplary computer screenshot in this embodiment in illustrated in FIG. 15. This diagram is merely an example, which should not unduly limit the scope of the claims herein. Person of ordinary skill in the art would recognize many variations, modifications, and alternatives.

While specific embodiments are described utilizing the security monitoring system, it is to be understood that the various techniques described throughout the present specification can also be implemented utilizing the wireless access system. A typical wireless access system comprises wireless access points (APs) which facilitate traffic forwarding between wired and wireless media, and an access management server which is in communication with the wireless access points over a computer network. The access management server can facilitate configuration of the access points and can also collect statistics from them. In certain embodiments (often referred to as “thin AP”), the wireless traffic is forwarded by the access point to the access management server (often called as “controller”) inside a “packet tunnel” between the access point and the controller, which in turn forwards the traffic to the other parts of the wired network. Similarly, the traffic destined to wireless medium flows through the controller to the access point inside the “packet tunnel”, which the access point then forwards to the wireless medium. In certain alternative embodiments (often referred to as “fat AP”), the wireless traffic is not routed through the controller.

In embodiments utilizing the wireless access system, the wireless access point can detect connection of the wireless client to itself or to another wireless access point in the system. Various techniques described throughout the present specification can then be used to determine if the wireless client is a smart device and to apply appropriate connection policies based on this determination. In this embodiment, blocking of unapproved clients can be performed “inline”, e.g., by way of a blocking filter on the wireless access point and/or the controller. The blocking filter can be enabled/disabled for specific wireless clients.

In a specific embodiment, the wireless access system and/or the security monitoring system such as the wireless intrusion detection/prevention system (WIPS) can co-operate with the mobile device management (MDM) system to facilitate the smart devices monitoring.

The WIPS typically includes sniffer devices and a WIPS server. The sniffers can scan one or more radio channels and report the wireless activity observed on those channels to the WIPS server. The WIPS can detect vulnerabilities and intrusions in the wireless network, based upon the information reported by the sniffers.

The wireless access system typically includes wireless access points and a wireless access management server.

In specific embodiments, the functionalities of the access point and the sniffer can be combined in a single radio device. In alternative specific embodiment, the functionality of the wireless access management server and the WIPS server can be combined in a common server device or in a common server instance spanning one or more server devices. In further alternative embodiment, the functionality of the MDM server can be provided along with the wireless access management server and/or the WIPS server in a common server device or in a common server instance spanning one or more server devices. In this embodiment, the API between the wireless access management system/WIPS system and the MDM system can also be implemented using techniques such inter-process communication, shared memory, shared file system, shared database, etc. In yet alternative specific embodiment, the WIPS is deployed as an overlay on the wireless access system. Any of the servers can be provided on-site or in the cloud (Internet). For example, additional details on providing servers in the cloud can be found in the U.S. Pat. No. 8,032,939 to Palnitkar et al., entitled “Method and System for Providing Wireless Vulnerability Management for Local Area Computer Networks”, issued on Oct. 4, 2011; which is herein incorporated by reference.

The MDM system typically comprises a server system which interacts with the MDM agents deployed on the smart mobile devices. The MDM system facilitates software distribution, policy management, security management, etc. on the smart mobile devices. Typically, an authorized smart mobile device is required to connect to the MDM server to download the MDM agent on it before it can be used to access the enterprise network. Thereafter, the MDM agent in co-ordination with the MDM server can facilitate deployment of various software, configuration, policy rules, security rules, usage rules, etc. on the smart mobile device. In a way, the MDM system “sanitizes” the smart mobile device so that it can be legitimately used in the enterprise network. The MDM-controlled devices are often called as the “managed” devices. Typically, the MDM agent contacts the MDM server whenever the device connects to network (e.g., over cellular network, over Wi-Fi, etc.) and synchronizes software, policies, rules, etc.

However, the present inventors have discovered that the MDM system fails to keep check on the smart mobile devices which do not install MDM agents on them prior to connecting to the enterprise network. This typically can happen, for example, when an employee attempts to connect a personal smart mobile device to the enterprise Wi-Fi. Notably, Wi-Fi authentication and encryption techniques such as WPA2 PEAP, that are currently state-of-the-art in the enterprise Wi-Fi networks, are inadequate to block unauthorized or personal smart mobile devices. This is because, employees can share their WPA2 PEAP usernames and passwords between the authorized (e.g., IT assigned devices that are managed by the MDM system) devices and the personal smart mobile devices (which are not under the purview of the MDM system), and thus connect personal smart mobile devices to the enterprise Wi-Fi networks without the administrator knowledge or permission. Connection of the personal mobile devices to the enterprise networks creates certain security vulnerabilities as previously discussed. The WIPS or the wireless access management system can facilitate monitoring and responding to such unauthorized wireless access in co-ordination with the MDM system, according to the present invention.

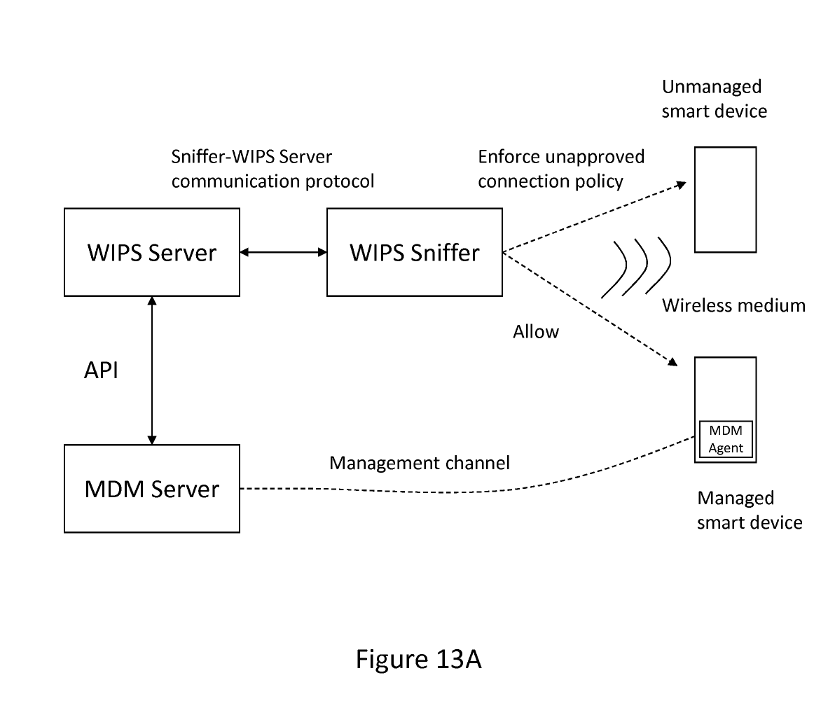

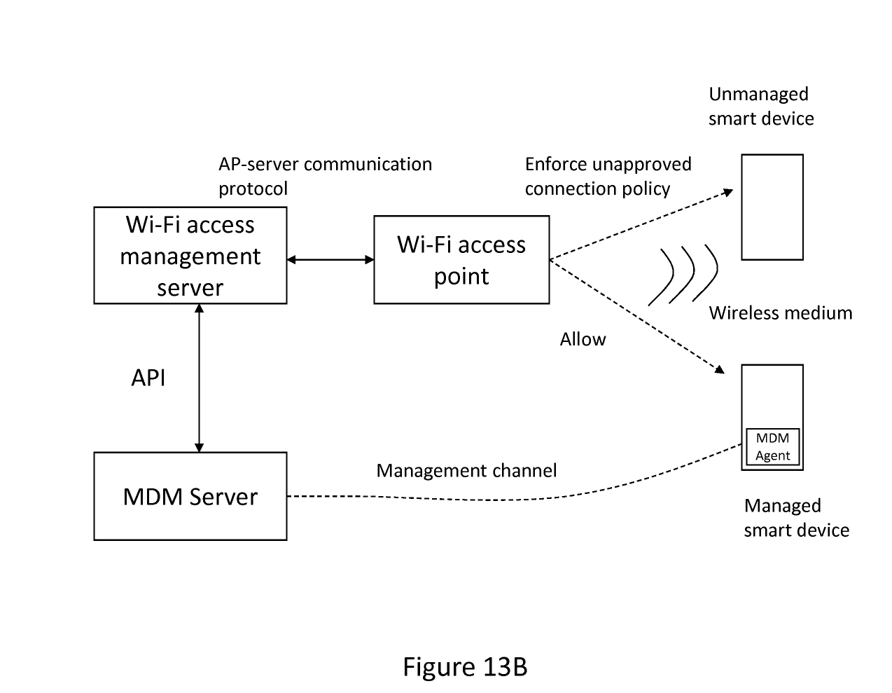

In a specific embodiment, the co-ordination with the MDM system can be facilitated by way of an API (Application Programming Interface) operating between the WIPS server and the MDM server, or operating between the wireless access management server and the MDM server. Examples of the API include web services API, SNMP (simple network management protocol), JAVA API etc. Notably, the API can operate over a computer network. For example, the WIPS or the wireless access management system can be provided with information (e.g., IP address, URL, etc.) to contact the MDM system over the network using the API or vice versa. As another example, the WIPS or the wireless access management system can be provided with information (e.g., protocol, port number, schema, etc.) necessary to receive communication from the MDM system or vice versa. Additional information such as authentication/encryption credentials (identity, password, certificates, etc.) may also be provided if required by the API. Utilizing such API, the MDM system can notify the wireless access management server or the WIPS server about the smart mobile devices which have the MDM agents installed in them. Exemplary network schematics according to specific embodiments of the present invention are illustrated in FIG. 13A and FIG. 13B. These diagrams are merely examples, which should not unduly limit the scope of the claims herein. Person of ordinary skill in the art would recognize many variations, modifications, and alternatives.

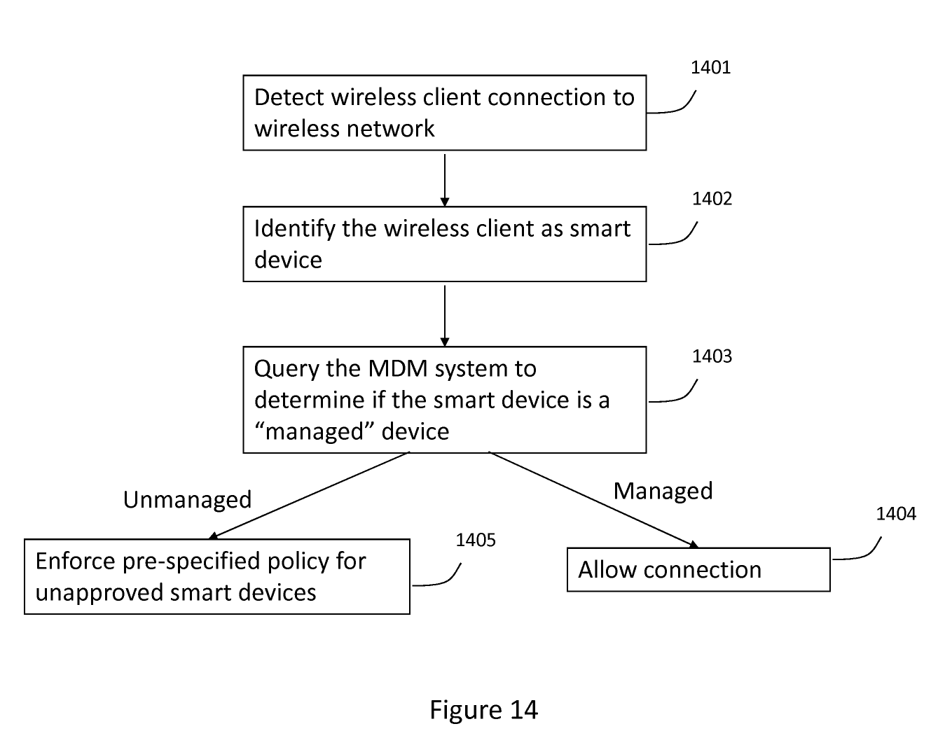

FIG. 14 illustrates an exemplary flow of steps in a method for smart mobile devices monitoring using the security monitoring system/access management system and the MDM system according to a specific embodiment of the present invention. This diagram is merely an example, which should not unduly limit the scope of the claims herein. Person of ordinary skill in the art would recognize many variations, modifications, and alternatives. As shown in FIG. 14, step 1401 can detect connection of a wireless client to the wireless access point. For example, the wireless access point can be an authorized Wi-Fi access point in the network. The detection can be performed by the sniffer which monitors wireless communications. Alternatively, the detection can be performed by the access point itself (or the controller) to which the wireless client connects.

Step 1402 can identify (e.g., fingerprint) the wireless client to be a smart mobile device. For example, any of the various methods described throughout the present specification can be used for the fingerprinting purpose.

Step 1403 can query the MDM system (e.g., using API between the WIPS server and the MDM server, or between the wireless access management server and the MDM server) to determine if the detected smart mobile device is a managed device. For example, query can be sent to the MDM system including a device identifier (e.g., wireless MAC address of the device). The MDM system can respond indicating if the corresponding device is managed by the MDM system or not. In an alternative embodiment, the MDM system can periodically send a list of the smart mobile devices that are managed by the MDM system. In this embodiment, the WIPS server or the wireless access management server can determine if the detected smart device is managed or not, e.g., by comparing the device identity with the list of the managed devices that is received from the MDM system.

If the detected smart device is determined to be a managed device, it may be allowed to connect to the wireless access point (step 1404). On the other hand, if the smart device is determined to be not a managed device, the connection may be called unapproved and specific connection restrictions may be enforced (step 1405). Alternatively, alert can be generated regarding unauthorized wireless access. In yet an alternative embodiment, the device may be redirected to a web page (called as “captive portal”) which can instruct and facilitate installing the MDM agent on the device.

Certain exemplary connection restrictions which may be imposed at step 1405 are illustrated by way of exemplary computer screenshots in FIG. 12 and FIG. 15.

An exemplary computer screenshot for displaying the smart mobile devices monitoring information according to a specific embodiment of the present invention is shown in FIG. 15A. This diagram is merely an example, which should not unduly limit the scope of the claims herein. Person of ordinary skill in the art would recognize many variations, modifications, and alternatives. As shown in FIG. 15A, the first column can indicate the status of the smart mobile device as approved or unapproved; the second column can indicate the type of the smart mobile device as identified by the system, the third column can indicate certain identifying information (e.g., MAC address) of the smart mobile device, the fourth column can indicate certain identifying information (e.g., MAC address) of the AP to which the connection is detected, and the fifth column can indicate the type of the AP as corporate access AP or guest access AP.

As also shown in FIG. 15A, the first iPhone is being classified as approved (with a checkmark) since it has connected to the guest access AP, while the second iPhone is being classified as unapproved (with a cross) since it has connected to the corporate access AP. This classification could for example be in relation to the policy (see FIG. 12): “Allow connection to guest network, but not corporate network for iPhone”, or it could be in relation to the policy: “Allow connection to Guest AP, but not Authorized AP” (see FIG. 15). In an embodiment, if the second iPhone were to later connect to the guest AP, it can be classified as approved, and if the first iPhone were to later connect to the corporate AP, it can be classified as unapproved. That is, the approved/unapproved status of the device can be in relation to its present connection. Alternatively, the device once classified as unapproved can stay unapproved irrespective of where it later connects.

As further shown in FIG. 15A, the BlackBerry and iPad devices are being classified as approved. This could for example be because the policy allows BlackBerry and iPads to connect to corporate wireless networks, such as the policy shown in FIG. 12: “Allow connection to corporate network for BlackBerry and iPad”. Alternatively, this approval can for example be because of the information received from the MDM system that these devices are managed devices. In an embodiment, the managed devices can be classified as approved even though the policy as in FIG. 12 or FIG. 15 disallows their present connections. In an alternative embodiment, certain devices can be approved (e.g., by the administrator) to make exceptions to policies, e.g., to approve CEO's iPad. FIG. 15A also shows Android device being classified as unapproved because of certain policy setting.

In an alternative specific embodiment, the co-ordination between the WIPS/the wireless access management system and the MDM system can be facilitated by way of an API (Application Programming Interface) operating between the WIPS server and the MDM agents installed on the smart mobile devices. In this embodiment, the MDM agents can be provided with the information (e.g., IP address, URL, credentials) to contact the WIPS server or the wireless access management server. When the smart mobile device including the MDM agent connects to the wireless network, the MDM agent can register with the WIPS server or the wireless access management server; which facilitates classifying the corresponding device as the approved smart mobile device. For example, the MDM agent can authenticate with the WIPS server or the wireless access management server and provide them with the device identifier of the host device (e.g., wireless MAC address of the device hosting the MDM agent). On the contrary, if there is no registration from the MDM agent even after the smart mobile device connects to the wireless network (e.g., within a timeout interval), the corresponding smart mobile device can be classified as the unapproved smart mobile device.

In an embodiment, the present invention provides an apparatus for smart mobile devices monitoring in wireless local area networks. The apparatus comprises a wireless security monitoring system comprising at least one sniffer that is capable of monitoring wireless communications within its vicinity and capable of communicating with a wireless security monitoring server over a computer network. The wireless security monitoring system includes a facility to receive configuration information for communicating with a mobile device management (MDM) system. The MDM system comprises an MDM server in communication with a plurality of MDM agents on a plurality of managed smart devices. The at least one sniffer is configured for detecting a wireless client operating within its vicinity from the monitored wireless communications. The wireless security monitoring system is configured for identifying the wireless client to be a smart mobile device. Moreover, the wireless security monitoring system is configured for receiving an indication from the MDM system regarding whether the wireless client is a managed device or not, and for classifying the wireless client as approved or unapproved smart mobile device based at least upon the indication received from the MDM system.

In an alternative embodiment, the present invention provides an apparatus for smart mobile devices monitoring in wireless local area networks. The apparatus comprises a wireless access system comprising at least one wireless access point that is capable of providing wireless access to a local area network for wireless clients within its vicinity and capable of communicating with a wireless access management server over a computer network. The wireless access management system includes a facility to receive configuration information for communicating with a mobile device management (MDM) system. The MDM system comprises an MDM server in communication with a plurality of MDM agents on a plurality of managed smart mobile devices. The at least one wireless access point permits a wireless client to connect to itself. Subsequent to the connection, the wireless access system is configured for identifying the wireless client to be a smart mobile device. Moreover, the wireless access system is configured for receiving indication from the MDM system regarding whether the wireless client is a managed device or not, and for classifying the wireless client as approved or unapproved smart mobile device based at least upon the indication received from the MDM system.

In the detailed description above, various specific embodiments have been described for thorough disclosure of the present invention. It is to be understood that while specific embodiments have been described, person of ordinary skill in the art can contemplate several alternatives and modifications based upon the teachings of the present specification, wherein one or more steps may be added, one or more steps may be deleted, one or more steps may be performed in different order, a plurality of steps may be combined into a single step, a single step may be split into a plurality of steps, a subset of steps are taken from a specific embodiment while another subset it taken from another specific embodiment, etc. Such obvious variants are included within the scope of the present invention.

What is claimed is:

1. A method for smart mobile devices monitoring in a computer local area network with wireless extension (wireless local area network), the method comprising:
installing a wireless security monitoring system comprising one or more sniffers positioned within a selected geographic region for monitoring of wireless communications within the selected geographic region, the one or more sniffers being in communication with a security monitoring server over a computer network;
configuring the security monitoring system to communicate with a mobile device management (MDM) system, the MDM system comprising an MDM server in communication with a plurality of MDM agents on a plurality of managed smart mobile devices;
detecting a wireless client operating within the selected geographic region using at least one of the one or more sniffers;
identifying the wireless client to be a smart mobile device;
receiving an indication at the security monitoring system from the MDM system regarding whether the wireless client is a managed device or not;
classifying the wireless client as approved or unapproved smart mobile device based at least upon the indication received from the MDM system.

2. The method of claim 1 further comprising initiating a process to disconnect the wireless client from the wireless local area network using the security monitoring system, responsive to the classifying the wireless client as the unapproved smart mobile device.

3. The method of claim 2 wherein the wireless local area network being an enterprise wireless local area network and the unapproved wireless client being a personal smart mobile device attempting connection to the enterprise wireless local area network.

4. The method of claim 1 wherein the identifying the wireless client to be a smart mobile device being based at least upon one or more fields in one or more packets transmitted by the wireless client, the one or more fields containing information which is characteristic of the wireless client being a smart mobile device.

5. The method of claim 1 further comprising configuring a wireless network access policy for smart mobile devices in the security monitoring system to at least identify a first portion of the wireless local area network where the unapproved smart mobile device is allowed to connect.

6. The method of claim 5 wherein the wireless network access policy is further based upon a type of a smart mobile device, the type of the smart mobile device being characterized by at least a device hardware type or at least a device operating system type.

7. The method of claim 6 further comprising identifying the type of the wireless client based at least upon one or more fields in one or more packets transmitted by the wireless client, the one or more fields containing information which is characteristic of the type of the wireless client.

8. The method of claim 5 wherein the first portion of the wireless local network being identified using an SSID (a service set identifier).

9. The method of claim 5 wherein the first portion of the wireless local area network being identified using a subnetwork number or a virtual local area network (VLAN) identifier, that is coupled to wireless medium via one or more wireless access points.

10. The method of claim 5 further comprising:
determining that the unapproved smart mobile device connects to a second portion of the wireless local area network different from the first portion; and
initiating a process to disconnect the unapproved smart mobile device from the second portion of wireless local area network.

11. A method for smart mobile devices monitoring in a computer local area network with wireless extension (wireless local area network), the method comprising:
installing a wireless access system comprising one or more wireless access points positioned within a selected geographic region to provide wireless access in a local area network, the one or more wireless access points being in communication with a wireless access management server over a computer network;
configuring the wireless access management server to communicate with a mobile device management (MDM) system, the MDM system comprising an MDM server in communication with a plurality of MDM agents on a plurality of managed smart mobile devices;
detecting a wireless client connecting to at least one of the one more wireless access points;
identifying the wireless client to be a smart mobile device ______;
receiving an indication at the wireless access management system from the MDM system regarding whether the wireless client is a managed device or not;
classifying the wireless client as approved or unapproved smart mobile device based at least upon the indication received from the MDM system.

12. The method of claim 11 further comprising initiating a process to disconnect the wireless client from the at least one of the one more wireless access points responsive to the classifying the wireless client as the unapproved smart mobile device.

13. The method of claim 12 wherein the process to disconnect including inline blocking of the wireless client in the at least one of the one more wireless access points.

14. The method of claim 12 wherein the wireless local area network being an enterprise wireless local area network and the unapproved smart mobile device being a personal smart mobile device attempting connection to the enterprise wireless local area network.

15. The method of claim 11 further comprising initiating a process to redirect the unapproved smart mobile device to the MDM system to facilitate installing an MDM agent on the unapproved smart mobile device.

16. The method of claim 11 further comprising configuring a wireless network access policy for smart mobile devices in the wireless access system to at least identify a first portion of the wireless local area network where the unapproved smart mobile device is allowed to connect.

17. The method of claim 16 wherein the wireless network access policy is further based upon a type of a smart mobile device, the type of the smart mobile device being characterized by at least a device hardware type or at least a device operating system type.

18. The method of claim 17 further comprising identifying the type of the wireless client based at least upon one or more fields in one or more packets transmitted by the wireless client, the one or more fields containing information which is characteristic of the type of the wireless client.

19. The method of claim 16 wherein the first portion of the wireless local network being identified using at least an SSID (a service set identifier), at least a subnetwork number that is coupled to wireless medium via the wireless access system, or at least a virtual local area network (VLAN) identifier that is coupled to wireless medium via the wireless access system.

20. The method of claim 16 further comprising:
determining that the unapproved smart mobile device connects to a second portion of the wireless local area network different from the first portion; and
initiating a process to disconnect the unapproved smart mobile device from the second portion of the wireless local area network.

21. A method for monitoring personal smart mobile devices in local area computer networks with wireless extensions (wireless local area networks), the method comprising:
configuring a wireless network access policy for one or more types of smart mobile devices, a type of a smart mobile device being characterized by at least a device hardware type or at least a device operating system type;
ascertaining a connection of a first wireless device to the wireless local area network;
determining type of the first wireless device based at least upon one or more fields in one or more packets transmitted by the first wireless device, the one or more fields containing information which is characteristic of the type of the first wireless device;
ascertaining violation of the wireless network access policy based at least upon the determined type of the first wireless device; and
responding to the violation of the wireless network access policy.

22. The method of claim 21 wherein the wireless network access policy for any type of a smart mobile device specifying whether the smart mobile device of that type is allowed or disallowed to connect to the wireless local area network.

23. The method of claim 21 wherein the wireless network access policy for any type of a smart mobile device specifying an identity of a portion of the wireless local area network where the smart mobile device of that type is allowed or disallowed to connect.

24. The method of claim 23 wherein the portion of the wireless local network being identified using an SSID (a service set identifier).

25. The method of claim 23 wherein the portion of the wireless local area network being identified using a subnetwork number and/or a virtual local area network (VLAN) identifier, that is coupled to wireless medium via one or more wireless access points.

26. The method of claim 21 wherein the wireless network access policy for any type of a smart mobile device identifying a location where the smart mobile device of that type is allowed or disallowed to connect to the wireless local area network.

27. The method of claim 21 wherein a type of a smart mobile device being selected from the group consisting of iPad, iPod, iPhone, Android, Blackberry, and Windows.

28. The method of claim 21 wherein the responding including generating an alert associated with the violation of the wireless network access policy.

29. The method of claim 21 wherein the responding including initiating a process to disconnect the first wireless device from the wireless local area network.

30. The method of claim 21 wherein the responding including providing physical location estimation of the first wireless device associated with the violation of the wireless network access policy.

31. The method of claim 1 wherein the one or more packets transmitted by the first wireless device being selected from the group consisting of mDNS packet, DHCP packet, and NETBIOS packet.
